(19) United States
(12) Patent Application Publication
(10) Pub. No.: US 2019/0249433 A1
(43) Pub. Date: Aug. 15, 2019

(54) A SUPPORT ARRANGEMENT

(71) Applicant: BLINDSPACE AB, 333 32 Smälandsstenar (SE)

(72) Inventors: Gaíus Henry GUEST, Kungsbaeka (SE); Benjamin NYKViST, Smälandsstenar (SE); Patrik ROSDAHL, Bjuv (SE); Anders SUNDELIN, Mölndal (SE)

(73) Assignee: BLINDSPACE AB, 333 32 Smålandsstenar (SE)

(21) Appl. No.: 16/343,753

(22) PCT Filed: Oct. 20, 2016
(86) PCT No.: PCT/EP2016/075265

§ 371 Date: Apr. 20, 2019

(51) Int. Cl. E04C 3/07; E06B 9/17; E06B 9/264; E06B 9/323; E06B 9/327; E06B 9/42; E06B 9/58

(52) U.S. Cl. CPC E04C 3/07; E06B 9/1703; E06B 9/264; E04C 2003/0417; E06B 9/327; E06B 9/42; E06B 9/58; E06B 9/323

(57) ABSTRACT

A support arrangement is provided for mounting in a wall or roof for supporting at least one extendable covering, the covering being arranged for movement between a retracted state and an extended state for at least partly covering an opening in the wall or roof. The support arrangement includes at least one elongated support member adapted to be attached to a wall portion or roof portion defining the opening and a closing structure for at least substantially concealing the elongated support member.

### BACKGROUND AND SUMMARY

The invention relates to a support arrangement for mounting in a wall or roof for supporting at least one extendable covering. The covering is arranged for movement between a retracted state and an extended state for at least partly covering an opening in the wall or roof, such as a window opening. The support arrangement comprises at least one elongated support member adapted to be attached to a wall portion or roof portion defining the opening.

Window coverings are used to cover a window to, for example, manage sunlight, to provide insulation, blackout, to ensure privacy or security, to keep insects out or for purely decorative purposes. Window coverings are usually on the interior side of windows, but exterior solutions are also available. Window coverings may also be referred to as window furnishings or window blinds.

One common type of covering comprises a sheet of material wound up on a roll, wherein the sheet of material may be extended from the roll by a rotation of the roll.

It is desirable to provide a support arrangement for mounting in a wall or roof for supporting at least one extendable covering for an opening, which support arrangement creates conditions for a plurality of different covering solutions in an aesthetically attractive way when the support arrangement is mounted in the wall or roof.

According to an aspect of the invention, a support arrangement for mounting in a wall or roof for supporting at least one extendable covering is provided, the covering being arranged for movement between a retracted state and an extended state for at least partly covering an opening in the wall or roof, wherein the support arrangement comprises at least one elongated support member adapted to be attached to a wall portion or roof portion defining the opening, characterized in that the support arrangement comprises a closing structure for at least substantially concealing the elongated support member.

The covering may be arranged to at least partially cover the opening in the extended state. Further, a fully retracted state corresponds to a first end position and a fully extended state corresponds to a second end position. Further, the covering may be arranged to substantially cover the complete opening in the second end position. Preferably, the covering is adapted for being positioned in a plurality of extension states between the retracted state and the extended state covering the opening to different extents. Further preferably, the covering may be extendable in a continuous way for assuming any intermediate position. Further preferably, the support arrangement may be provided with a device, such as a motor, for an automatic movement of the covering.

Further, the covering may be extendable in parallel with a plane. The covering may be designed so that the boundaries of the covering define a rectangular shape in the extended state. The covering may further be continuous, like a blind or screen, or discontinuous, like a plurality of interconnected and spaced parallel vane members. Further, the covering may be rolled onto a roll. In the case the covering is discontinuous, the vane members may be interconnected via cords and assume a packed condition with decreased internal spacing in the retracted state.

Further, the elongated support member may have an extension in its longitudinal direction designed for at least as long as its associated side of the opening. In this way, the covering may be arranged to cover a complete extension of the opening along said side.

Further, the elongated support member may have a longitudinal extension along a straight line and be substantially rigid.

Further, the elongated support member may be adapted to be attached to the wall portion in a fixed state via one or several connection means, like screws or rivets or glue.

The term “closing structure” may comprise a cover attached to or adapted for being attached to the elongated support member. More specifically, such a cover may form a one-piece unit with the elongated support member or be detachable. According to an alternative or complement, the term “closing structure” may comprise other concealing structures, like a board and or filler/paint, forming an integral part of the wall or roof portion. The closing structure is preferably opaque.

The language “the closing structure at least substantially concealing the elongated support member” comprises a complete concealing of the elongated support member. Further, it comprises that a small portion of the elongated support member may be visible, such as through a slot or passage for the covering. More specifically, the language “the closing structure at least substantially concealing the elongated support member” comprises that the closing structure conceals the elongated support member to at least 70%, specifically at least 80% and especially at least 90%.

Such a support arrangement comprising a closing structure for at least substantially concealing the elongated support member creates conditions for an aesthetically attractive solution when the support arrangement is mounted in the wall or roof due to the fact that not only the elongated support member being concealed but also other structures, such as a covering roll and associated holders and guides for the covering may be concealed.

Further, such a support arrangement creates conditions for an architect or a designer during planning a construction or building comprising a window opening to at least temporarily conceal the elongated support member and any other structures, such as the covering roll and associated holders and guides for the covering or the locations of such operative structures during installation. Further, such a support arrangement creates conditions for postponing selection of one of a plurality of available covering solutions, such as the number of coverings and the types of coverings.

Further, the support arrangement may be built in adjacent a window opening at the time of construction of a building or subsequently as a retrofit.

According to one embodiment, the closing structure comprises at least one elongated cover, which is adapted for connection to the at least one elongated support member in a way that a longitudinal direction of the at least one elongated cover is in parallel with a longitudinal direction of the at least one elongated support member in a connected state.

Such a support arrangement creates conditions for a further aesthetically attractive solution when the support arrangement is mounted in the wall or roof.

The elongated cover may be connected to the elongated support member in such a way that one side of the elongated cover faces the window opening when mounted in the wall or roof portion.

The wall or roof portion may be provided with an elongated groove with a depth substantially similar with a transverse extension of the elongated support member and elongated cover in a connected state for at least substantially completely receiving the elongated support member and the elongated cover. More specifically, the groove may have such a shape and dimension that it matches the exterior shape and dimension of the elongated support member for a tight fit. More specifically, the groove may be designed so that an exterior surface of the elongated cover is substantially flush with the adjacent wall portion surface, creating an aesthetically attractive solution with no projecting parts.

Further, the elongated cover may have a longitudinal direction along a substantially straight line. Further, the elongated cover may be substantially rigid. Further, the elongated cover may be formed by a plate. Further, the plate may be rectangular with a main extension in parallel with its longitudinal direction.

The elongated cover and the elongated support member may be designed in a way that the elongated cover at least substantially conceals the elongated support member when the elongated cover and the elongated support member are arranged in a connected state. In this way, the elongated cover will at least substantially conceal the elongated support member when the elongated support member is positioned in an associated groove in the wall or roof portion. Accordingly, the elongated cover will at least substantially conceal also further structures attached to the elongated support member, such as a roll of the covering and/or guides for the covering arranged with the elongated support member.

The elongated cover and the elongated support member may be of at least substantially the same length and width. There may be one single elongated cover adapted to be connected to a single associated elongated support member or a plurality of elongated covers adapted to be connected to a single elongated support member.

Preferably, the elongated support member and the elongated cover may have such profiles that they, in a connected state, define an elongated space with a main extension direction in the longitudinal direction of the elongated support member and the elongated cover. Thus, the elongated support member and the elongated cover may have such profiles that they, in a connected state, define a hollow or tubular structure for housing certain structures, like a roll for the covering and/or a guide for the covering.

Further, the elongated support member and the elongated cover may be designed such that they, in a connected state, define an elongated space that is open in at least one of its opposite ends. In this way, the elongated support member and the associated elongated cover may be arranged in a wall or roof portion for supporting and/or guiding an edge of the covering during operation and/or when the covering is in a static state at least partly covering the window opening.

Further, the elongated support member and the elongated cover may be designed such that they, in a connected state, define an elongated space that is closed in a direction transverse to the longitudinal direction of the elongated support member and the elongated cover. In other words, the elongated support member and the elongated cover may be designed such that they, in a connected state, define a circumferentially at least substantially continuous tube. It creates conditions for an easy and aesthetically attractive mounting of the elongated support member to the wall or roof (and especially in an associated groove) while concealing any structures positioned inside of the tube.

Further, the elongated support member may have a profile defining a channel with a main extension direction in a longitudinal direction of the elongated support member, wherein the channel is open in one direction transverse of the longitudinal direction. The elongated cover may be designed to at least substantially close this opening of the channel.

According to a further embodiment, the closing structure comprises a plurality of elongated covers, wherein at least one pair of the elongated covers is adapted to form a slot for the covering. The elongated covers may be adapted for connection to an elongated support member accommodating the covering, wherein the slot forms a passage for the covering.

Alternatively, the elongated covers may be adapted for connection to an elongated support member sideways of the covering, wherein the slot is adapted to support or guide a side edge of the covering or even only conceal a guide for the covering edge.

According to a further embodiment, the at least one elongated cover comprises a first engagement means and the at least one elongated support member comprises a second engagement means, wherein the first and second engagement means are adapted for a detachable connection of the at least one elongated cover to the at least one elongated support member.

The first and second engagement means may be designed to form a click or clip connection. In other words, the first and second engagement means may be designed to form a push fit solution. More specifically, the first and second engagement means may be designed to allow for an engagement via a push movement of the elongated cover in relation to the elongated support member and especially via a push movement in a direction transverse to its longitudinal direction. Thus, the first and second engagement means may be designed to allow for being released from engagement via a pull movement of the elongated cover in relation to the elongated support member and especially via a pull movement in a direction transverse to its longitudinal direction.

More specifically, the first and second engagement means may be adapted to be elastic in a transverse direction for, during connection, allowing movement of one part passed a widened section of the other part and thereafter urged back to an engagement state in a narrow section on another side of the widened section.

Further, the first engagement means on the elongated cover may face in a direction perpendicular to the longitudinal direction of the elongated cover. Further, the second engagement means on the elongated support member may face in a direction perpendicular to the longitudinal direction of the elongated support member.

Further, the first engagement means may comprise two spaced engagement portions. Likewise, the second engagement means may comprise two spaced engagement portions. Further, the first and second engagement means may be arranged in such a way that a first one of the engagement portions of the elongated cover is adapted to engage a first one of the engagement portions of the elongated support member and a second one of the engagement portions of the elongated cover is adapted to engage a second one of the engagement portions of the elongated support member. Further, the first and second engagement means may be arranged in such a way that the first and second engagement portions may engage each other simultaneously during an engagement movement of the elongated cover relative to the elongated support member.

The support arrangement according to this embodiment creates conditions for multiple options, like mounting of the elongated support member (and possibly with a first completely concealing elongated cover applied) and a postponed selection of a covering solution, such as the number of coverings and the types of coverings, without negatively impacting a visual appearance of the wall or roof. Further, the support arrangement may be mounted to the wall or roof portion without any holders for the covering(s) and with elongated covers without any slot/channel so that it may not be seen that the wall or roof portion is prepared for supporting one or several coverings. At a later stage, one may select a covering solution and then remove the existing covers, mount the covering(s) and attach a new cover or set of covers with slots/channels in accordance with the selected number of coverings.

Further, this embodiment creates conditions for an exchange of an installed first covering solution (a first number of covers and a first type of coverings) to a second covering solution (a second number of coverings and/or a second type of coverings) in a way without negatively impacting a visual appearance of the wall or roof. This may be achieved by exchanging the first covering holders and the first covers adapted for the first number of coverings with second covering holders and second covers adapted for the second number of coverings.

According to a further embodiment, each one of the first and second engagement means defines an elongated shape in parallel with the longitudinal direction of the respective one of the at least one elongated support member and the at least one elongated cover.

The second engagement means of the elongated support member may be arranged along a sideways edge of the elongated support member. More specifically, the second engagement means may comprise two spaced engagement portions arranged along opposite sideways edges of the elongated support member.

Each one of the first and second engagement means may be a continuous elongated means like a rib/slot structure or a discontinuous structure. For example, one of the first and second engagement means may be a continuous structure while the other may be discontinuous. For example, one of the first and second engagement means may be formed by a slot and the other one may be formed by a plurality of spaced discrete projections.

More specifically, the elongated cover may be designed to conceal the elongated support member seen from view in a direction perpendicular to the longitudinal direction. It creates conditions for an aesthetically attractive appearance in that only the elongated cover may be seen from said direction. More specifically, by arranging the elongated support member substantially completely received in a groove formed in the wall or roof portion, only an external surface of the elongated cover may be viewed from an internal position of the opening when the at least one elongated cover and the at least one elongated support member are in a connected state. The term “at least substantially conceals” comprises a design where the elongated cover (or a plurality of elongated covers) forms one slot or several slots.

The elongated support member may be adapted to form a sideways support structure for supporting a side edge of the covering. In this case, the elongated support member and the elongated cover may be designed so that they define a space sufficient for accommodating the edge of the covering and possibly accommodating a guide for guiding the edge of the covering. The guide may alternatively be called a rail or track.

According to an alternative or complement, the elongated support member may be adapted to form a housing for accommodating the at least one covering in the retracted state. In this case, the elongated support member and the elongated cover may be designed so that they define a space sufficient for accommodating the at least one covering in a fully retracted state.

According to one example, the at least one elongated support member and the at least one elongated cover are adapted to jointly define a substantially rectangular shape in a cross section perpendicular to the longitudinal direction when the at least one elongated cover and the at least one elongated support member are in a connected state.

A rectangular cross section creates conditions for a proper mounting of a back plate/panel of the elongated support member to the wall portion, and especially when mounting in a groove having a corresponding rectangular shape with a bottom surface and two opposite side surfaces.

According to one example, the elongated support member comprises a back wall and two spaced side walls forming three sides of the rectangle. Further, the elongated cover may be formed by a single plate-shaped wall forming a fourth side of the rectangle. Further, the elongated support member may be a one-piece unit. Further, the elongated support member may have a profile with a U-shaped cross section.

According to a further embodiment, the at least one elongated support member has a shape defining an elongated aperture extending in parallel with the longitudinal direction of the at least one elongated support member and the at least one elongated cover is adapted to at least substantially close the elongated aperture when the at least one elongated cover and the at least one elongated support member are in a connected state.

This embodiment creates further conditions for multiple options for a covering solution comprising the number of coverings and type of coverings and especially a postponed decision of selection of a specific covering solution.

According to a further embodiment, one of the at least one elongated support member and/or one of the associated at least one elongated cover is adapted for supporting an edge of the at least one extendable covering, which edge is in parallel with a movement direction between the retracted state and the extended state.

According to one example, the covering is mainly guided via a guide in or at the at least one support member, wherein the cover has more of an aesthetic function concealing the guide and allowing the covering to run between the retracted state and the extended state. Alternatively, both the elongated support member and its associated elongated cover may be adapted for guiding the covering. It may be realized via the elongated cover being provided with a projection defining a slot for the covering edge and the elongated support member being provided with a receptacle for the projection, possibly engaging the projection, wherein the receptacle is provided with a guide for guiding the covering edge. According to a further example, the elongated cover may be adapted for guiding the covering and the elongated support member forms a support structure between the elongated cover and the wall or roof portion.

According to one example, one of the at least one elongated support members and/or one of the at least one elongated cover is adapted for supporting edges of a plurality of extendable coverings which edges are in parallel with a movement direction of the respective covering between the retracted state and the extended state. This creates conditions for selection of one of several covering solutions.

According to one example, an edge of the covering may be received by the elongated cover. In other words, the covering extends passed an external surface of the cover facing away from the elongated support member. The edge of the covering may be guided between opposite parts of the elongated cover defining a slot. The edge of the covering may be guided by a guide in or at the elongated support member facing the elongated cover.

According to one example, the elongated cover may define a slot for receiving and/or guiding the covering allowing an edge of the covering to extend passed the elongated cover in an extended state. Alternatively, a pair of elongated covers spaced apart may define a slot for receiving and/or guiding an edge of the covering.

According to one example, the elongated cover or covers adapted for a specific elongated support member may have a symmetrical design in a transverse direction with regard to the position or positions of the slot(s).

According to one design of a support arrangement, it comprises a single elongated support member and that elongated support member is adapted for supporting/guiding an edge of the at least one extendable covering. Thus, this design does not comprise any elongated support member for accommodating the covering. The support arrangement may comprise at least one covering arranged at the elongated support member and/or a holder for the at least one covering arranged at the elongated support member or at least the elongated support member being adapted for housing the holder. Another holder for the covering may be arranged in the wall portion at an opposite side of the support arrangement in relation to the opening. Alternatively, both holders may be arranged directly in the wall portion in a position aligned with the elongated support member. Thus, a support arrangement may be devoid of an elongated support member accommodating at least one covering

According to a further embodiment, one of the at least one elongated support member is adapted for accommodating the at least one extendable covering in the retracted state.

More specifically, the elongated support member may be adapted for accommodating the at least one extendable covering in in a fully retracted state.

According to a further embodiment, one of the at least one elongated support member is adapted for housing a plurality of extendable coverings.

According to another design of a support arrangement, it comprises a single elongated support member and that elongated support member is adapted for accommodating the at least one extendable covering in the retracted state. Thus, this design does not comprise any sideways elongated support members for supporting/guiding an edge of the covering.

According to a further embodiment, one of the at least one elongated cover is adapted for a connection to the associated at least one elongated support member allowing a portion of the at least one extendable covering to extend passed the at least one elongated cover when the at least one extendable covering is in the extended state.

The elongated cover may define a slot or passage for receiving the covering allowing a deployed portion of the at least one covering to extend in the slot passed the elongated cover. Alternatively, a pair of elongated covers is adapted to be arranged spaced apart defining a slot or passage for receiving the covering.

According to a further embodiment, the at least one elongated support member adapted for accommodating the covering in the retracted state and the elongated support member adapted for supporting an edge of the covering are arranged in relation to each other in such a way that the longitudinal directions of the two elongated support members are substantially perpendicular to each other.

This embodiment creates conditions for forming a support arrangement with different designs, such as extending along two, three or four sides of a rectangular shape. Especially, two elongated support members for the supporting/guiding of the edge of the covering may be arranged spaced and in parallel with each other. More specifically, the two elongated support members for the supporting/guiding of the edge of the covering may be arranged on opposite sides of the opening. More specifically, the two elongated support members for the supporting/guiding of the edge of the covering may be arranged so that guides for the covering edge face each other. Further, an elongated support member housing at least one covering may be arranged at one end of the two side support members in such a way that opposite edges of the covering may be received/supported/guided by each one of the sideways elongated support members. Each one of the elongated support members may have a longitudinal direction extending along a substantially straight line. Thus, this embodiment of the support arrangement extends along three sides of the rectangular shape.

According to an alternative of the last-mentioned embodiment, a support arrangement may be provided with extension along two sides of a rectangular shape.

According to one alternative, the support arrangement is provided with two elongated support members for the supporting/guiding of the edge of the covering spaced apart and in a parallel relationship. More specifically, the two elongated support members for the supporting/guiding of the edge of the covering may be arranged on opposite sides of the opening. The support arrangement may comprise at least one covering arranged between the two sideways elongated support members and/or holders for the at least one covering arranged at each one of the two sideways elongated support members or at least the two sideways elongated support members being adapted for housing the holders and the at least one covering. Alternatively, such holders may be arranged directly in the wall portion in a position aligned with the sideways elongated support members. Thus, a support arrangement may be devoid of an elongated support member housing at least one covering and bridging the distance between the two sideways elongated support members.

According to another alternative of the last-mentioned embodiment, a support arrangement may be provided with two elongated support members for accommodating at least one covering each, which support members are spaced apart and in a parallel relationship. More specifically, the two elongated support members for the accommodation of the covering may be arranged on opposite sides of the opening. Thus, a support arrangement may be devoid of any elongated support member supporting/guiding the at least one covering.

According to a still further alternative of the last-mentioned embodiment, a support arrangement may be provided with a single elongated support member for accommodating at least one covering and a single elongated support member for the supporting/guiding of the edge of the covering.

According to a further embodiment, the at least one elongated support member adapted for supporting an edge of the extendable covering has a width of the aperture substantially commensurate with a width of a corresponding elongated aperture of the at least one elongated support member adapted for accommodating the extendable covering in the retracted state.

This design creates conditions for mounting of the support arrangement in the wall or roof portion in a first step and then in a second, consecutive step, mounting the covering(s) in the support arrangement. This procedure opens up for different constructional solutions. Preferably, the support arrangement is adapted for mounting the covering(s) via holders in the elongated support member adapted for accommodating the at least one extendable covering in the retracted state. By the sideways elongated support member having a width of the elongated aperture for the elongated cover being substantially commensurate with a width of the elongate aperture of the elongated support member adapted for accommodating the extendable covering, the sideways elongated support member is adapted for different number of coverings. Further, the covering(s) may extend into the sideways elongated aperture(s) during mounting of the covering(s) to the support arrangement.

According to a further embodiment, the closing structure comprises material, which is adapted for being removably connected to the wall portion or roof portion defining the opening. According to one example, the material is formed by a removable elongated strip of material. It may be disposable, for example embedded in the wall or roof portion. Further, the strip may be accessible ro removal at one end by a visual or tactile indication or projection.

According to a further embodiment, the support arrangement is adapted to be arranged in the wall portion or roof portion defining the opening in a non-operative state, in which the closing structure at least substantially conceals the at least one elongated support member and arranged in such a way that it is accessible for activation to an operative state, when desired by removal of at least a part of the closing structure.

According to a further embodiment, which is a further development of the last-mentioned embodiment, the closing structure comprises an elongated cover adapted for completely concealing the elongated support member in the non-operative state and wherein the elongated cover is detachably arranged for being exchanged to a plurality of elongated covers in the operative state.

According to a further embodiment, the support arrangement comprises at least one means for holding the extendable covering.

It is also desirable to provide a solution for a support arrangement for mounting in a wall or roof for supporting at least one extendable covering, which solution creates conditions for a plurality of different covering solutions in an aesthetically attractive way when mounted in the wall or roof.

According to an aspect of the invention, a set of elongated covers adapted for connection to at least one elongated support member for mounting in a wall or roof for supporting at least one extendable covering for an opening in the wall or roof is provided.

The set of elongated covers creates conditions for a postponed selection of a certain covering solution during planning/building of a building/house or apartment comprising the opening in the wall or roof. Further, the set of elongated covers creates conditions for replacement or exchange of an existing covering solution. The set of elongated covers may either comprise a single set for a certain number of coverings or a plurality of sets for the plurality of number of available covering solutions. The set of elongated covers may be connected to the elongated support member(s) in a way that a longitudinal direction of each one of the elongated covers is in parallel with a longitudinal direction of the associated elongated support member.

According to one embodiment, the set comprises a plurality of elongated covers, wherein at least one pair of the elongated covers is adapted to form a slot for the covering.

According to one embodiment, at least one of the elongated covers comprises a first engagement means adapted for a detachable connection to a second engagement means of the elongated support member.

According to a further embodiment, the first engagement means defines an elongated shape in parallel with a longitudinal direction of the associated elongated cover.

According to one example, the set of elongated covers comprises a plurality of covers for a single support member, wherein two of the covers being provided with a portion of the first engagement means. In the case of a single covering, two covers are provided, each one with a portion of the first engagement means. The two covers being adapted for defining a slot for the covering. In the case of two coverings, three covers are provided, wherein each one of the two outermost ones being provided with a portion of the first engagement means. The three covers are adapted for defining two slots for the two coverings.

According to a further embodiment, the set of elongated covers comprises at least one elongated cover adapted for connection to an elongated support member, which is adapted for accommodating the at least one extendable covering in the retracted state.

According to a further embodiment, the set of elongated covers comprises at least one elongated cover adapted for connection to a support member adapted for supporting an edge of the at least one extendable covering, which edge is in parallel with a movement direction of the covering between a retracted state and an extended state.

According to a further embodiment, the set of elongated covers comprises an elongated cover member, which is adapted for being attached to an edge of the covering, and wherein the elongated cover member and the at least one elongated cover being designed so that the elongated cover member may at least substantially block a passage for the covering passed the at least one elongated cover.

According to a further aspect, a wall or roof portion is provided defining an opening, wherein the wall or roof portion is provided with a support arrangement according to any one of the above embodiments.

According to one embodiment, the wall or roof portion has an elongated groove adapted for receipt of one of the at least one elongated support member in such a way that an exterior surface of the at least one elongated support member and/or the at least one elongated cover is at least substantially flush with the adjacent surface of the wall or roof portion.

According to one example, the at least one elongated support member and/or the at least one elongated cover may be at least substantially flush with wall surfaces on opposite sides of the groove. Further, the elongated cover may be plate shaped wherein an exterior surface of the plate may be in a plane spaced a small distance from a plane in parallel with the adjacent exterior surface(s) of the wall. The elongated cover may be arranged overlapping with a portion of the wall, wherein the spacing may correspond to a thickness of the cover.

It is also desirable to provide a method for mounting a support arrangement in a wall or roof for supporting at least one extendable covering, which method creates conditions for an aesthetically attractive solution when mounted in the wall or roof.

According to an aspect of the invention, a method is provided for mounting a support arrangement in a wall or roof portion for supporting at least one extendable covering, the covering being arranged for movement between a retracted state and an extended state for at least partly covering an opening in the wall or roof, wherein the method comprises the step of attaching at least one elongated support member of the support arrangement to the wall portion or roof portion defining the opening, characterized by the step of applying a closing structure for at least substantially concealing the at least one elongated support member.

The closing structure may be applied to the elongated support member before the elongated support member is attached to the wall portion or roof portion or it may be applied after installation of the elongated support member to the wall portion or roof portion.

According to one embodiment, the method comprises the step of connecting at least one elongated cover of the support arrangement to the elongated support member in a way that a longitudinal direction of the elongated cover is in parallel with a longitudinal direction of the elongated support member.

According to a further embodiment, the method comprises the step of building the support arrangement into the wall portion or roof portion in a non-operative state, in which the closing structure at least substantially conceals the elongated support member and arranged in such a way that it is accessible for activation to an operative state, when desired by removal of at least a part of the closing structure.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a perspective view from the top of a first embodiment of a support arrangement,

FIG. 2 is a cross section of the support arrangement in FIG. 1,

FIG. 3 is a perspective view from the top of a second embodiment of a support arrangement,

FIG. 4 is a cross section of the support arrangement in FIG. 3,

FIG. 5 is a perspective view from the top of a third embodiment of a support arrangement,

FIG. 6 is a perspective view of a wall portion with the support arrangement according to FIG. 5 installed,

FIG. 7 is a perspective view of the arrangement according to FIG. 6 with elongated covers removed,

FIGS. 8 and 9 are cross sections of the arrangement according to FIG. 6,

FIG. 10 is a perspective view of a set of covers for replacing the cover according to FIG. 1-2,

FIG. 11 is a perspective view of a set of covers for replacing the cover according to FIG. 3-4,

FIG. 12 is a perspective view similar to FIG. 6 with a covering installed and the elongated covers according to FIG. 10-11 installed,

FIG. 13 shows an alternative set of covers for replacing the cover according to FIG. 1-2,

FIG. 14 shows an alternative set of covers for replacing the cover according to FIG. 3-4,

FIG. 15a is a cross section of FIG. 14,

FIG. 15b is an alternative to the embodiment of FIG. 15a,

FIG. 16 is similar to the view in FIG. 12 with two coverings applied and the sets of covers according to FIGS. 13 and 14,

FIG. 17 shows a cut perspective view of a support arrangement according to an alternative embodiment,

FIG. 18 shows a covering applied in the embodiment according to FIG. 17,

FIG. 19 shows a further alternative in relation to FIG. 17,

FIG. 20-21 show alternative designs of the elongated cover,

FIGS. 22a and 22b show a step during mounting of a covering in a support arrangement,

FIG. 23 shows an alternative modular design of a support member for housing a covering in a cross section,

FIG. 24 shows a further alternative of a support arrangement applied in a groove in a wall,

FIG. 25 shows the alternative in FIG. 24 with material removed and a covering applied in the slot formed by the removed material,

FIGS. 26 and 27 show an alternative design of a covering for the support arrangement in two different states,

FIGS. 28 and 29 show a further alternative design of a covering for the support arrangement in two different states,

FIG. 30 shows a support arrangement with a motorized covering applied,

FIG. 31-34 show a further embodiment of the support arrangement in different views,

FIG. 35 shows an alternative embodiment in relation to FIG. 31,

FIG. 36 shows a support arrangement applied in a roof opening according to a first embodiment, and

FIG. 37 shows a support arrangement according to an alternative to FIG. 36.

### DETAILED DESCRIPTION

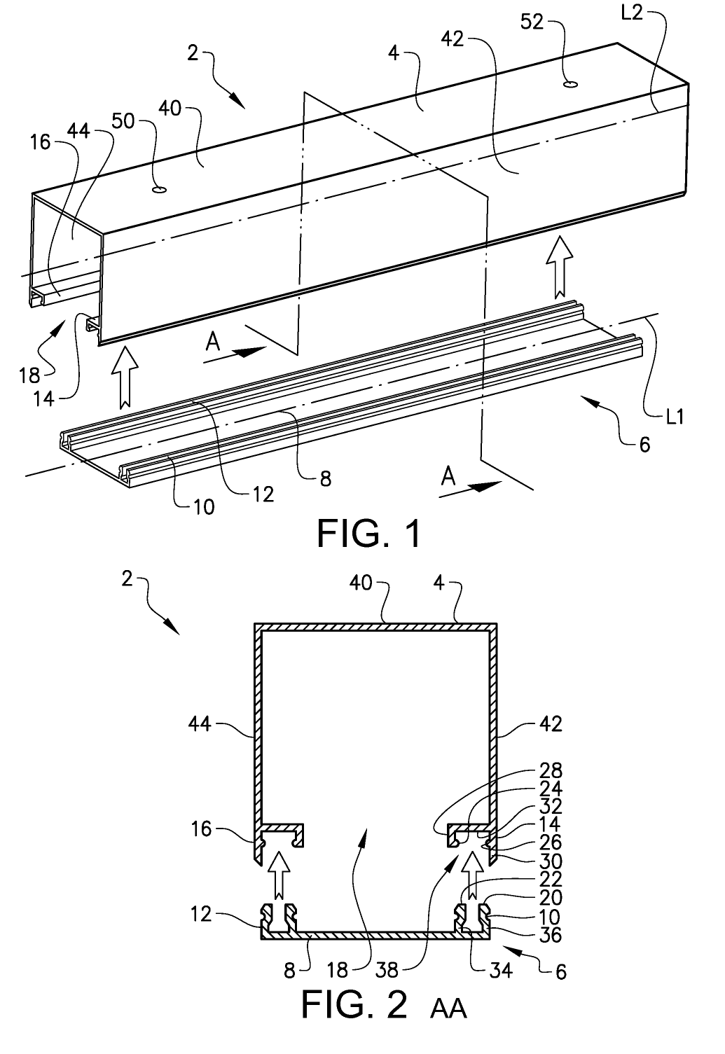

FIGS. 1 and 2 show a first embodiment of a support arrangement 2 for mounting in a wall or roof for supporting at least one extendable covering (not shown). The covering may be arranged for movement between a retracted state and an extended state for at least partly covering an opening in the wall or roof. The support arrangement 2 comprises an elongated support member 4 adapted to be attached to a wall portion or roof portion defining the opening. More specifically, the elongated support member 4 is adapted for accommodating at least one extendable covering in the retracted state.

The support arrangement 2 further comprises a closing structure 6 for at least substantially concealing the elongated support member 4 when it is installed in the wall or roof portion.

The closing structure 6 comprises an elongated cover 8, which is adapted for connection to the elongated support member 4 in a way that a longitudinal direction L of the elongated cover 8 is in parallel with a longitudinal direction L2 of the elongated support member 4 in a connected state. Further, the elongated cover 8 is devoid of any slot for the covering.

The elongated cover 8 comprises a first engagement means 10,12 and the elongated support member 4 comprises a second engagement means 14,16. The first and second engagement means 10,12,14,16 are adapted for a detachable connection of the elongated cover 8 to the elongated support member 4.

Each one of the first and second engagement means 10,12,14,16 is formed in a one-piece unit with the respective one of the elongated cover 8 and the elongated support member 4.

Each one of the first and second engagement means 10,12,14,16 defines an elongated shape in parallel with the longitudinal direction of the respective one of the elongated support member 4 and the elongated cover 8. More specifically, the first and second engagement means 10,12,14,16 are complimentary to each other. One of the first and second engagement means 10,12,14,16 has a female shape and the other one of the first and second engagement means 10,12,14,16 has a male shape.

The first and second engagement means 10,12,14,16 are designed to form a click connection. More specifically, at least one of the first and second engagement means 10,12,14,16 is elastic in a transverse direction for, during connection, allowing movement of one elastic part 20,22 passed a transverse projecting section 24,26 of the other part 28,30 and being elastically displaced for being retracted in an engagement state in a seat 32 on another side of the transverse projecting section 24,26.

Each one of the first engagement means 10,12 comprises a pair of parallel ribs 34,36, which are spaced apart in a transverse direction of the elongated cover 8. Each one of the second engagement means 14,16 comprises a channel 38 adapted for receipt of the ribs 34,36.

The elongated support member 4 has a shape defining an elongated aperture 18 extending in parallel with the longitudinal direction L2 of the elongated support member 4 and the elongated cover 8 is adapted to at least substantially close the elongated aperture 18 when the elongated cover 8 and the elongated support member 4 are in a connected state.

Further, the elongated support member 4 comprises an elongated back plate 40 and two spaced elongated side plates 42, 44 forming a U-shape in cross section. Further, the back plate 40 and the two spaced elongated side plates 42, 44 are formed in a one-piece unit. More specifically, the elongated support member 4 has a rectangular shape in a cross section, wherein the elongated aperture defines an open side of the rectangle. More specifically, the elongated support member 4 has a substantially square shape in a cross section. Other designs are of course possible, especially with such a design that a depth of the elongated support member is larger than a height of the elongated support member for housing several coverings.

The elongated cover 8 is formed by an elongated rectangular plate, which is adapted to match the boundaries of the elongated aperture 18.

Further, the elongated support member 4 comprises means 50,52 for attachment of the elongated support member 4 to the wall or roof portion. The attachment means 50,52 are here formed by through holes in the back plate 40 for receipt of fasteners, like screws or rivets.

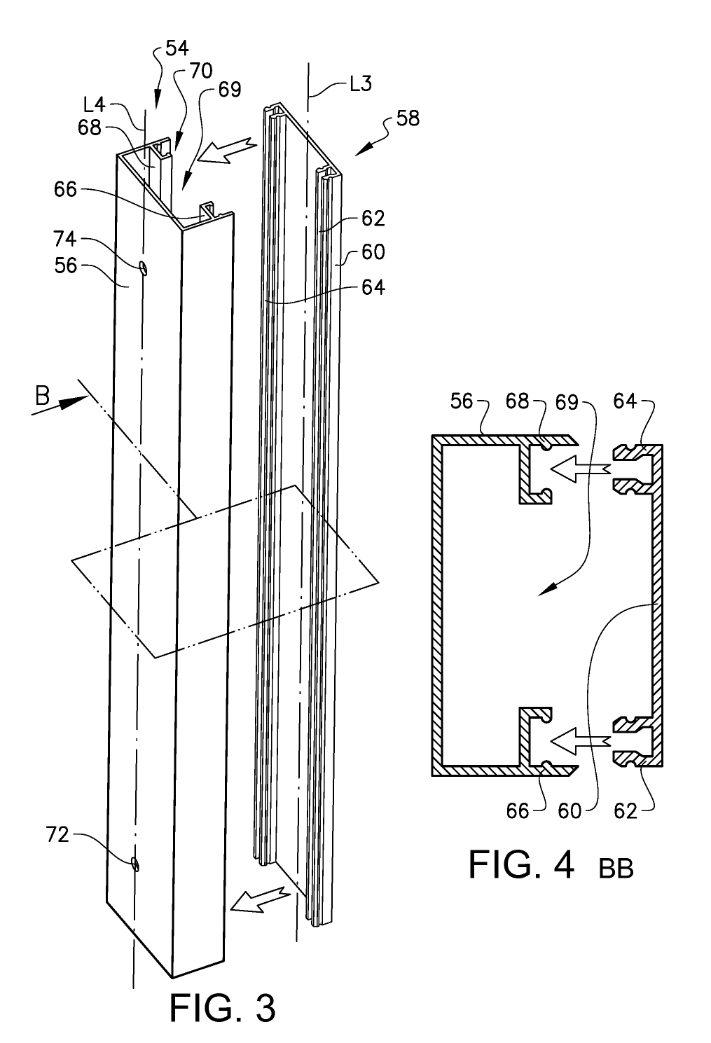

FIGS. 3 and 4 show a second embodiment of a support arrangement 54 for mounting in a wall or roof for supporting the at least one extendable covering (not shown). The support arrangement 54 comprises an elongated support member 56 adapted to be attached to a wall portion or roof portion defining the opening. More specifically, the elongated support member 56 is adapted for supporting an edge of the at least one extendable covering, which edge is in parallel with a movement direction between the retracted state and the extended state.

The support arrangement 54 further comprises a closing structure 58 for at least substantially concealing the elongated support member 56. The closing structure 58 comprises an elongated cover 60, which is adapted for connection to the elongated support member 56 in a way that a longitudinal direction L3 of the elongated cover 60 is in parallel with a longitudinal direction L4 of the elongated support member 56 in a connected state. Further, the elongated cover 60 is devoid of any slot for the covering.

The elongated cover 60 comprises a first engagement means 62,64 and the elongated support member 56 comprises a second engagement means 66,68. In a similar way as has been described above, the first and second engagement means 62,64,66,68 are adapted for a detachable connection of the elongated cover 60 to the elongated support member 56.

The elongated support member 56 has a shape defining an elongated aperture 69 extending in parallel with the longitudinal direction L4 of the elongated support member 56 and the elongated cover 60 is adapted to at least substantially close the elongated aperture 69 when the elongated cover 60 and the elongated support member 56 are in a connected state.

The support arrangement 54 has to a great extent a similar design as has been described above for the support arrangement 2 according to the first embodiment. The following description of the second embodiment of the support arrangement 54 will therefore focus on the differences in relation to the first embodiment of the support arrangement 2.

The elongated support member 56 according to the second embodiment has substantially the same width as a width of the support member 4 according to the first embodiment. Further, the elongated support member 56 according to the second embodiment has a substantially smaller depth in relation to a depth of the support member 4 according to the first embodiment. This is due to the fact that the elongated support member 4 according to the first embodiment is adapted for accommodating one or a plurality of coverings while the elongated support member 56 according to the second embodiment is adapted for supporting and/or guiding an edge of the covering during movement of the covering. The depth and width are defined in perpendicular directions and both are perpendicular to the longitudinal direction of the respective elongated support member 4, 56. In other words, the elongated support member 56 according to the second embodiment has a rectangular shape in a cross section with a longer extension in the width direction than in the depth direction.

Each one of the elongated support member 4 according to the first embodiment and the elongated support member 56 according to the second embodiment is provided with at least one means 72,74 for connection to the wall portion. The connection means 72,74 are formed by through holes for receipt of a fastener, such as a screw or rivet.

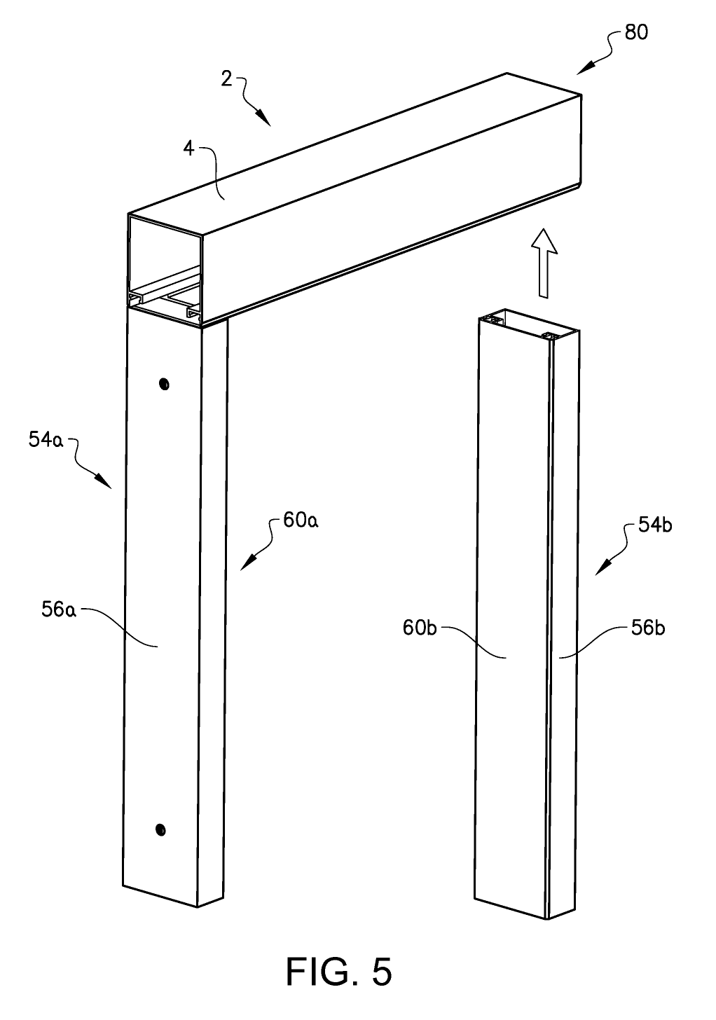

The elongated support member 4 according to the first embodiment and the elongated support member 56 according to the second embodiment may be arranged in relation to each other in a way that the longitudinal directions are perpendicular to each other, see FIG. 5. Further, the elongated support member 56 according to the second embodiment has an open end 70 in its longitudinal direction for allowing movement of the covering from a retracted state inside the elongated support member 4 according to the first embodiment and into the elongated support member 56 according to the second embodiment.

FIG. 5 is a perspective view from the top of a third embodiment of a support arrangement 80. The support arrangement 80 according to the third embodiment comprises one support arrangement 2 according to the first embodiment and two support arrangements 54a, 54b according to the second embodiment, wherein the two support arrangements 54a, 54b according to the second embodiment are positioned so that the elongated covers 60a, 60b face each other. Further, the two support arrangements 54a, 54b according to the second embodiment are positioned spaced from each other and in parallel relationship. Further, the two elongated support members 56a, 56b of the support arrangements 54a, 54b according to the second embodiment are arranged at opposite ends of the elongated support member 4 of the support arrangement 2 according to the first embodiment.

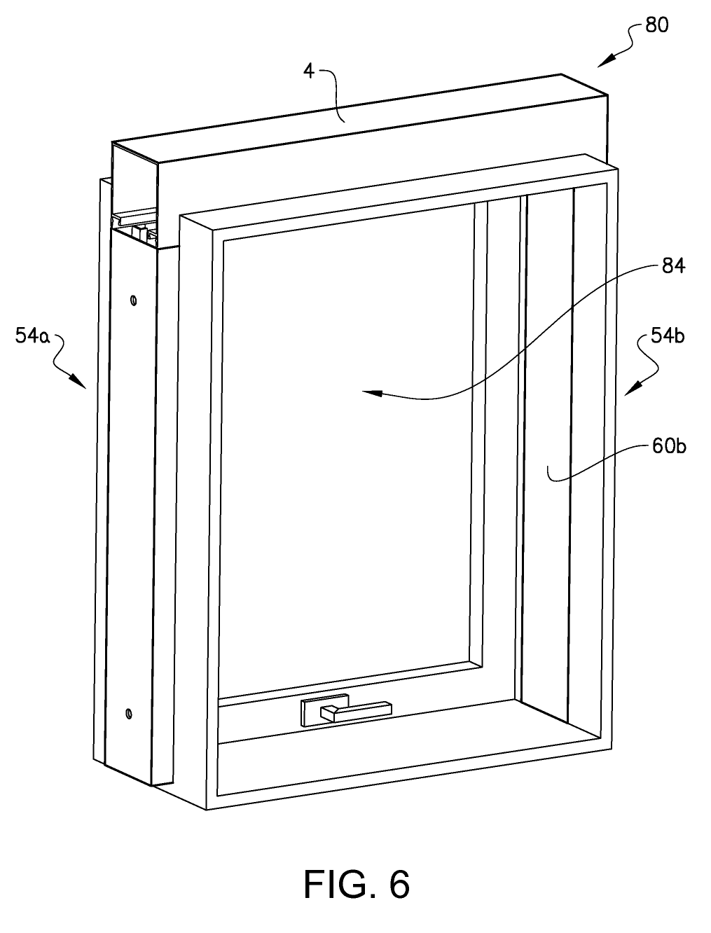

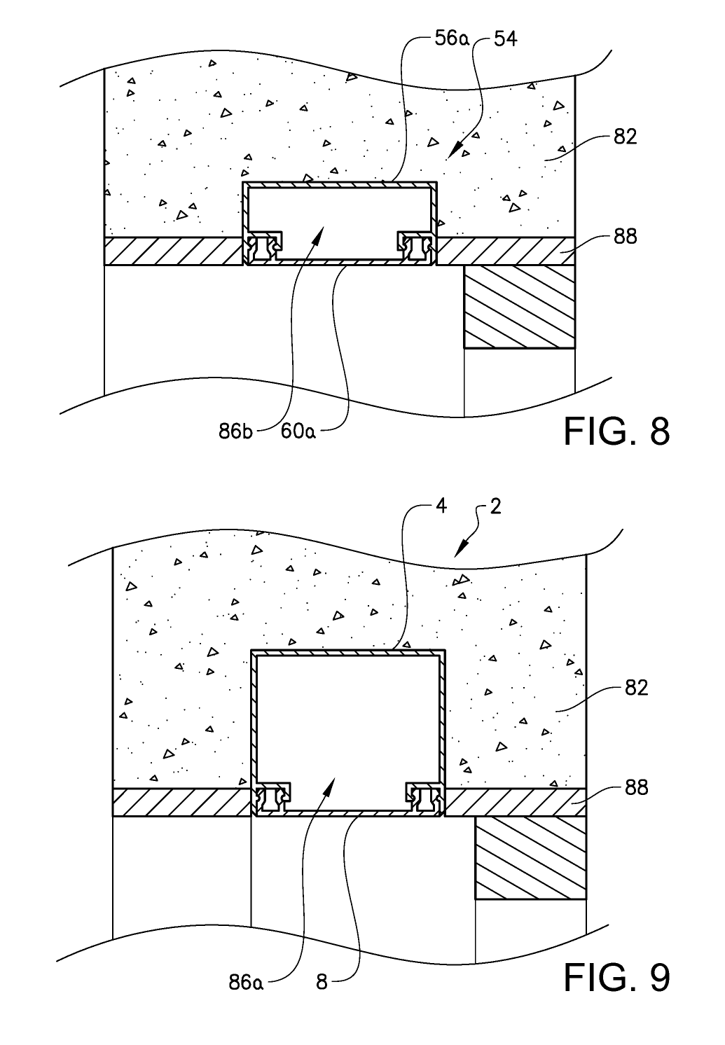

FIG. 6 is a perspective view of a wall portion 82 defining a window opening 84. The wall portion 82 is provided with the support arrangement 80 according to figure. More specifically, the wall portion 82 has an elongated groove 86a, 86b, see FIGS. 8-9, adapted for receipt of the elongated support members 4, 56a, 56b. More specifically, the elongated groove 86a, 86b extends along three sides of a rectangle. More specifically, the elongated support members 56a, 56b according to the second embodiment are arranged at the respective ends of the elongated support member 4 according to the first embodiment in a way that an installed covering may be extended from a retracted state within the elongated support member 4 while its edge being supported and/or guided by the elongated support members 56a, 56b according to the second embodiment.

The support arrangement 80 is arranged in such a way that an exterior surface of the at least one elongated support member 4, 56a, 56b is at least substantially flush with the adjacent surface of the wall or roof portion, see also FIGS. 8 and 9.

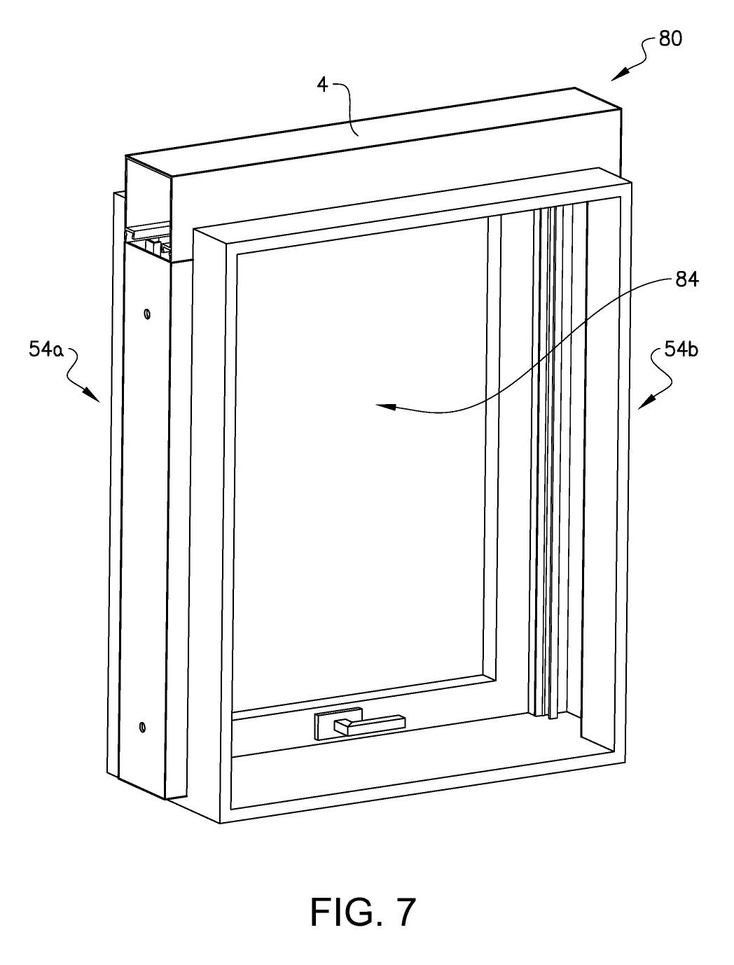

FIG. 7 is a perspective view of the wall portion 82 defining the window opening 84 similar to FIG. 6, but with the elongated end covers 8, 60a, 60b removed.

FIGS. 8 and 9 shows a cross sectional view of the support arrangement 54 according to the second embodiment and the support arrangement 4 according to the first embodiment, respectively, installed in the wall portion 82. The wall portion 82 comprises a board, like a plasterboard 88.

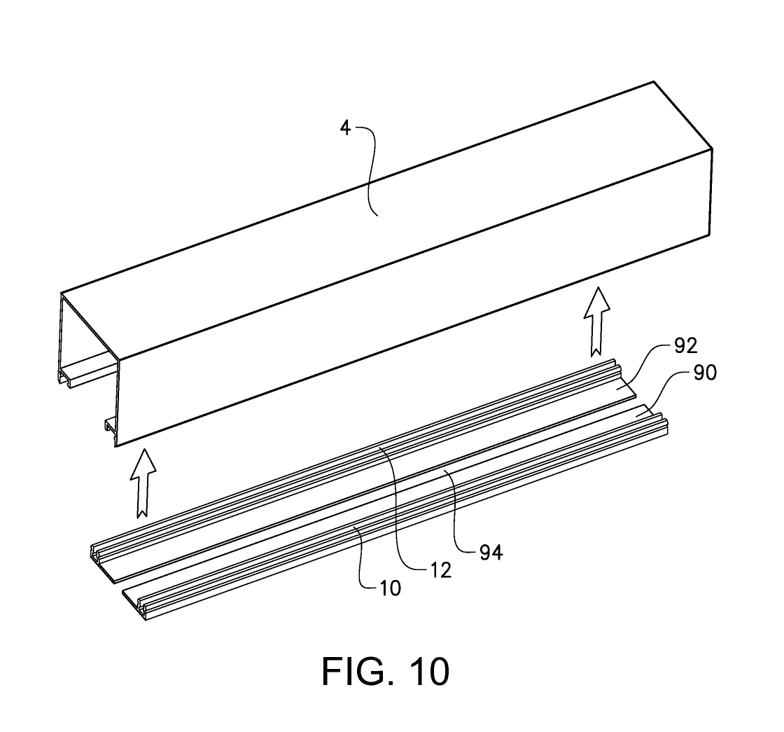

FIG. 10 shows a pair of elongated covers 90, 92 adapted for replacing the first applied elongated cover 8. Each one of the of elongated covers 90, 92 is provided with engagement means 10,12 similar to the engagement means of the first applied elongated cover 8. The pair of elongated covers 90, 92 is adapted for allowing a portion of the at least one extendable covering to extend passed the pair of elongated covers when the at least one extendable covering is in an extended state. More specifically, the elongated covers 90, 92 define an intermediate slot 94 for the extendable covering.

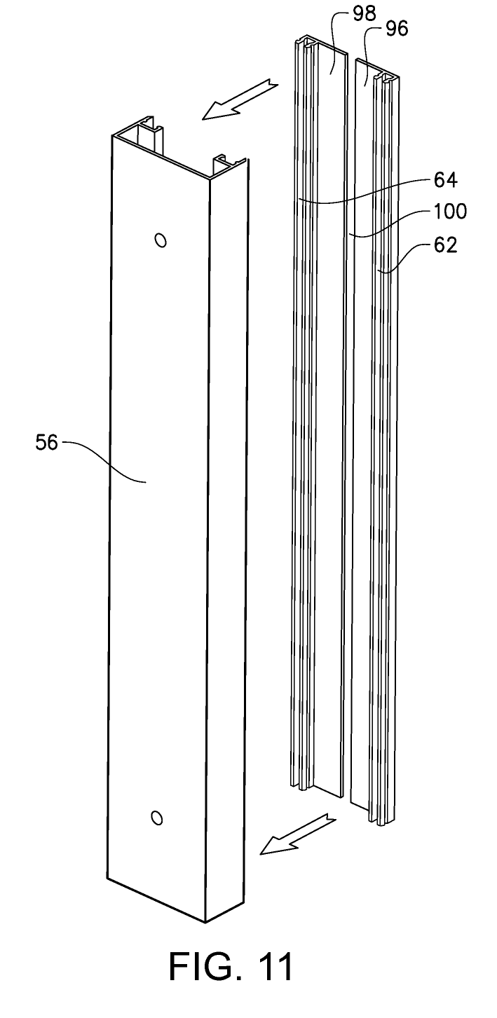

FIG. 11 shows a pair of elongated covers 96, 98 adapted for replacing the first applied elongated cover 60. Each one of the of elongated covers 96, 98 is provided with engagement means 62,64 similar to the engagement means of the first applied elongated cover 60. The pair of elongated covers 96, 98 is adapted for receiving an edge of the extendable covering. More specifically, the elongated covers 90, 92 define an intermediate slot 94 for receiving an edge of the extendable covering.

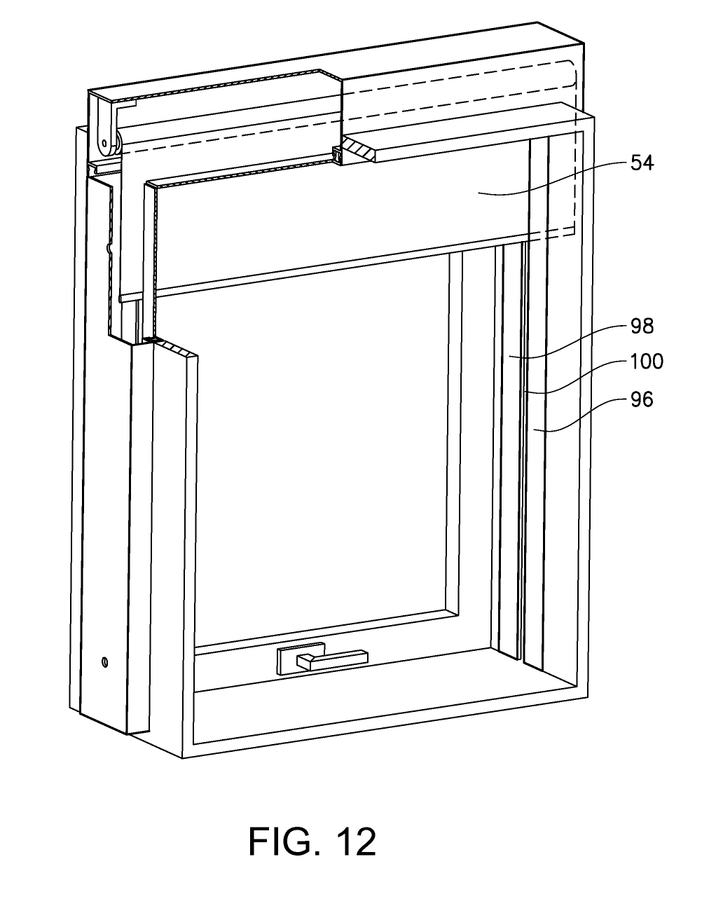

FIG. 12 is a perspective view similar to FIG. 6 with a covering 46 installed and the pairs of elongated covers 90, 92, 96, 98 according to FIG. 10-11 installed. The elongated covers 96, 98 for the sideways elongated support members are designed so that the slot 100 is in alignment with the slot 94 between the elongated covers 90, 92.

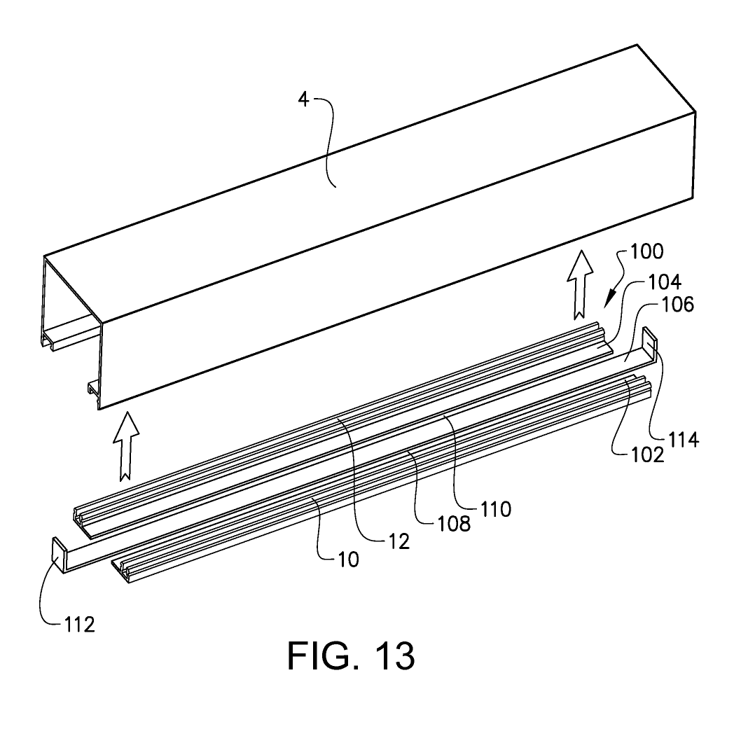

FIG. 13 shows a set of covers 100 for the elongated support member 4 adapted for accommodating two coverings. More specifically, the set of covers 100 comprises three elongated covers 102,104,106 arranged in parallel with each other and defining two slots 108,110. Each one of the outer elongated covers 102, 104 is provided with engagement means 10,12 similar to the engagement means of the first applied elongated cover 8. The intermediate elongated cover 106 is adapted to be connected to the wall portion or the associated elongated support member. The intermediate elongated cover 106 is formed by an elongated plate with a bent portion 112,114 at each end. Each one of the bent portions 112,114 may be provided with a hole for fastening of the intermediate elongated cover 106 via a fastener, such as a screw or rivet.

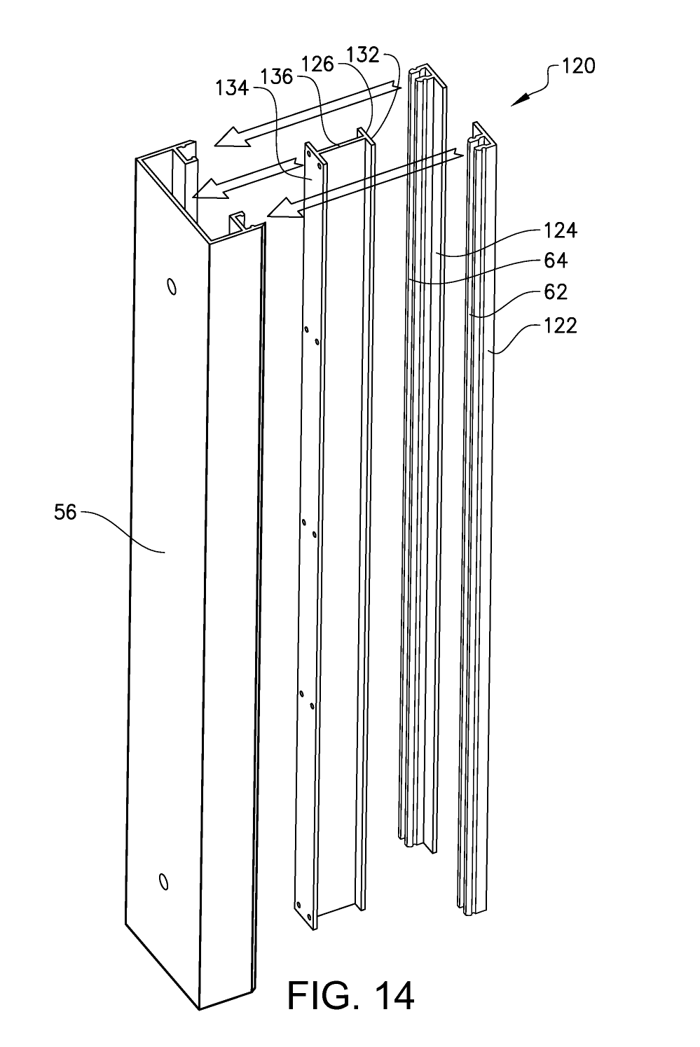

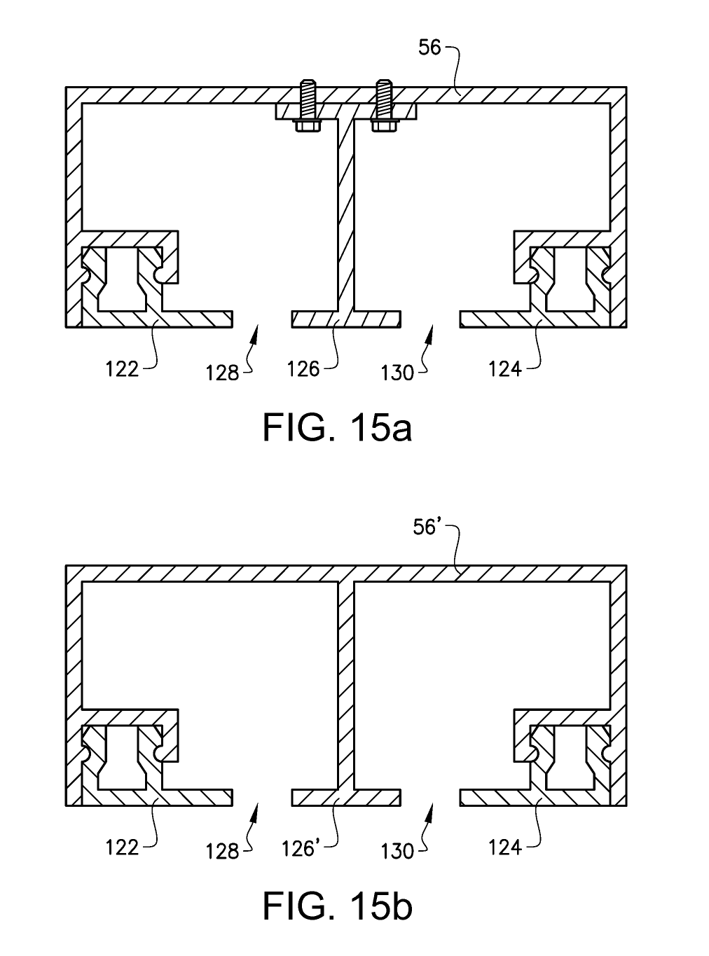

FIG. 14 shows a set of covers 120 for the elongated support member 56 adapted for supporting an edge of two extendable coverings. More specifically, the set of covers 120 comprises three elongated covers 122,124,126 arranged in parallel with each other and defining two slots 128,130 (see FIG. 15a). Each one of the outer elongated covers 122, 124 is provided with engagement means 62,64 similar to the engagement means of the first applied elongated cover 60. The intermediate elongated cover 126 is adapted to be connected to a back plate of the associated elongated support member 56. The intermediate elongated cover 126 is formed by an elongated member with a cover plate 132 for concealing the elongated support member, a fastening plate 134 for fastening of the intermediate elongated cover 126 to the elongated support member and a bridging plate 136 bridging the distance between the cover plate and the fastening plate. The fastening plate 134 is provided with a hole for fastening of the intermediate elongated cover 126 via a fastener, such as a screw or rivet. The intermediate elongated cover 126 is formed in a one-piece unit.

FIG. 15b shows an alternative design in relation to FIG. 15a. More specifically, the intermediate elongated cover 126′ is formed in a one-piece unit with the elongated support member 56′.

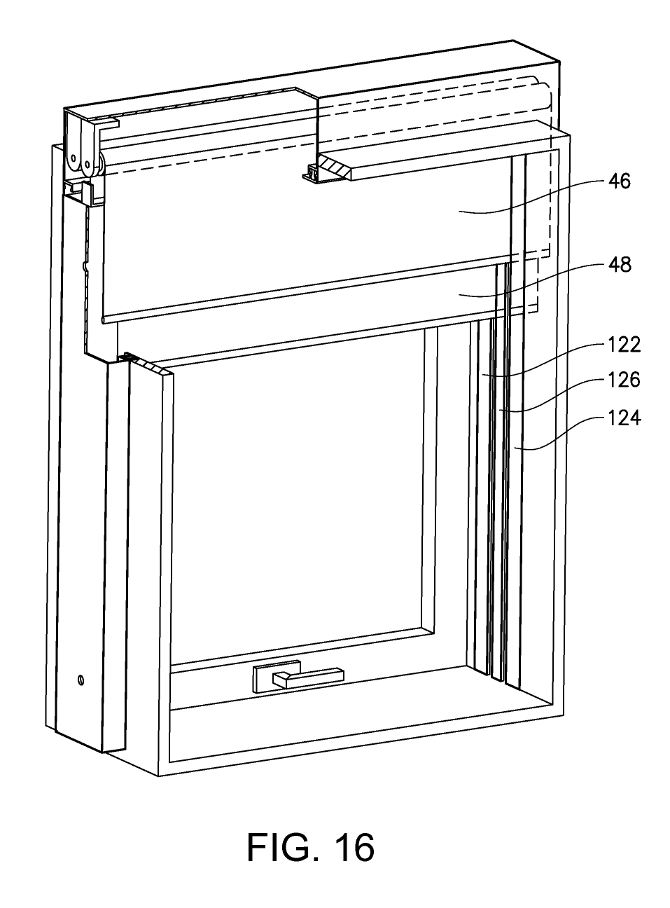

FIG. 16 is a perspective view similar to FIG. 12 with two coverings 46,48 installed and the sets of covers 100, 120 according to FIG. 13-14 installed.

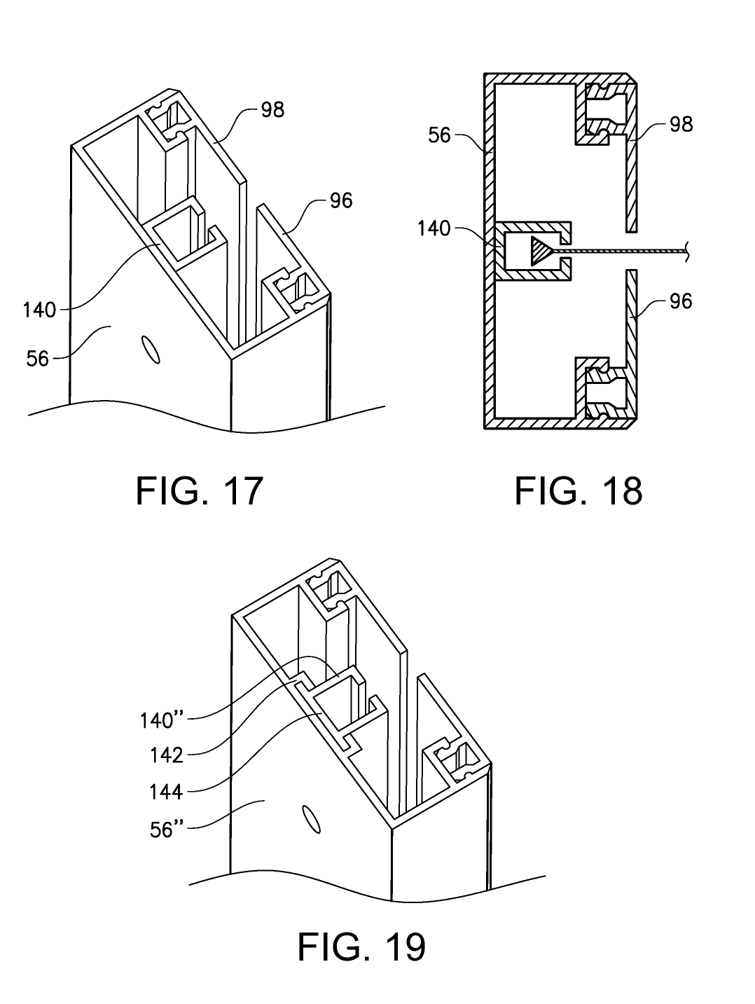

FIG. 17-18 show the support arrangement according to FIG. 11, wherein a guide 140 for guiding an edge of the covering is installed. More specifically, the guide 140 is elongated and extends in parallel with the longitudinal direction of the elongated support member 56. More specifically, the guide 140 is attached to the elongated support member 56. In other words, the support arrangement is adapted for more or less any type of guide.

FIG. 19 shows an alternative to the arrangement of FIG. 17, wherein the elongated support member 56″ and the guide 140″ are provided with means for engagement 142,144 with each other. In other words, the elongated support member 56′ is adapted for a certain type of guide 140′.

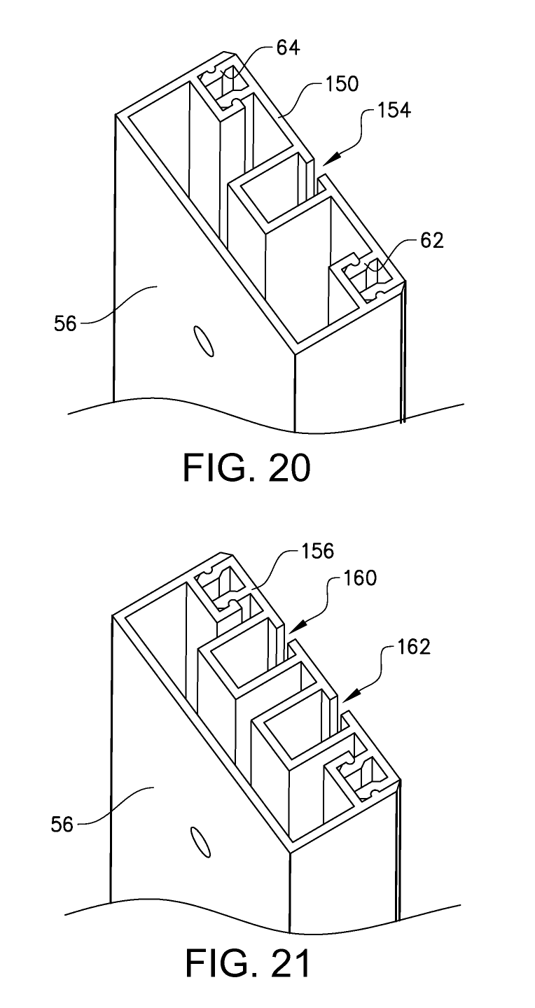

FIG. 20 shows a further alternative of a cover 150 for the elongated support member 56 for a single covering. More specifically, the cover 150 comprises a single elongated cover 150. The elongated cover 150 is provided with an elongated receptacle or channel 154 for guiding of the edge of the covering.

FIG. 21 shows a further alternative of a cover 156 for the elongated support member 56 for two coverings. More specifically, the cover 156 comprises a single elongated cover. The elongated cover 156 is provided with two parallel and spaced elongated receptacles or channels 160, 162 for guiding of the edges of the coverings.

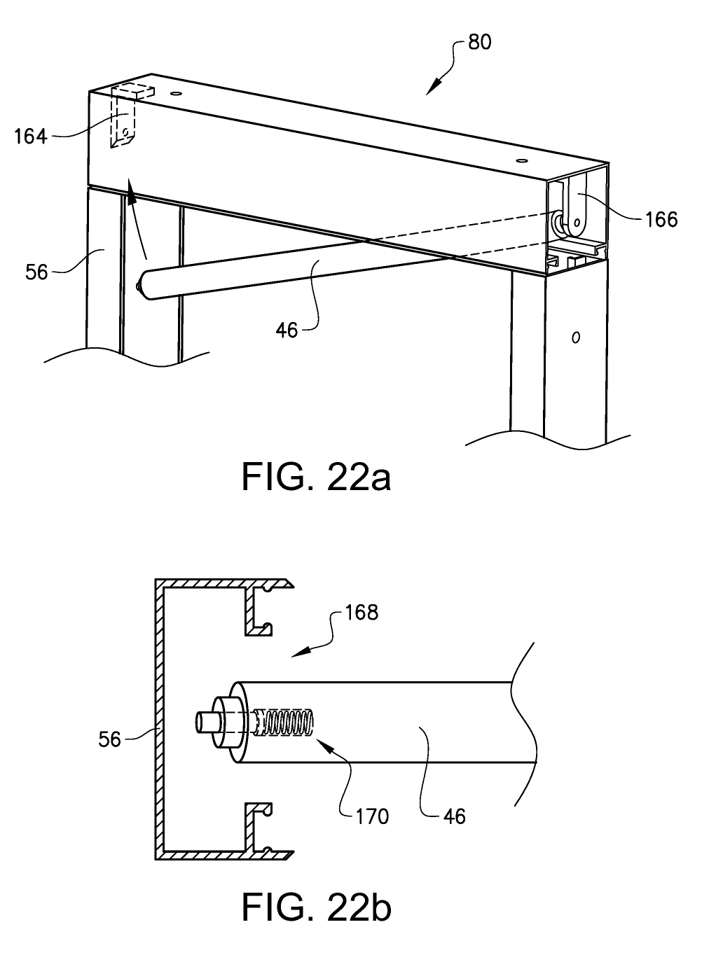

FIG. 22a and FIG. 22b show a step of mounting the covering 46 to the support arrangement 80 according to FIG. 6. The support arrangement comprises at least one means 164,166 for holding the extendable covering 46. In a first step, the holding means 164,166 for the covering 46 are mounted to the upper elongated support member 4 (and/or to the wall portion). Further, the covering 46, which is rolled onto a roll, is first engaged with one end in one of the holding means 166 in an inclined state and then pivoted so that the other end is engaged with the other holding means 164. The sideways elongated support member 56 has a shape allowing an end of the covering 46 to project into its elongated aperture 69. Further, the covering 46 may have a spring biased mechanism 170 at the other end for engaging the associated mounting.

The at least one means 164,166 for holding the extendable covering 46 may be provided in the support arrangement 80 before it is installed in the wall or roof portion, or alternatively be arranged at a later stage when it is decided to use the support arrangement 80 for a covering solution. Further, the support arrangement 80 allows for installing different types of coverings 46 and associated holding means 164, 166. Further, the support arrangement 80 allows for installing a single covering or a plurality of coverings 46.

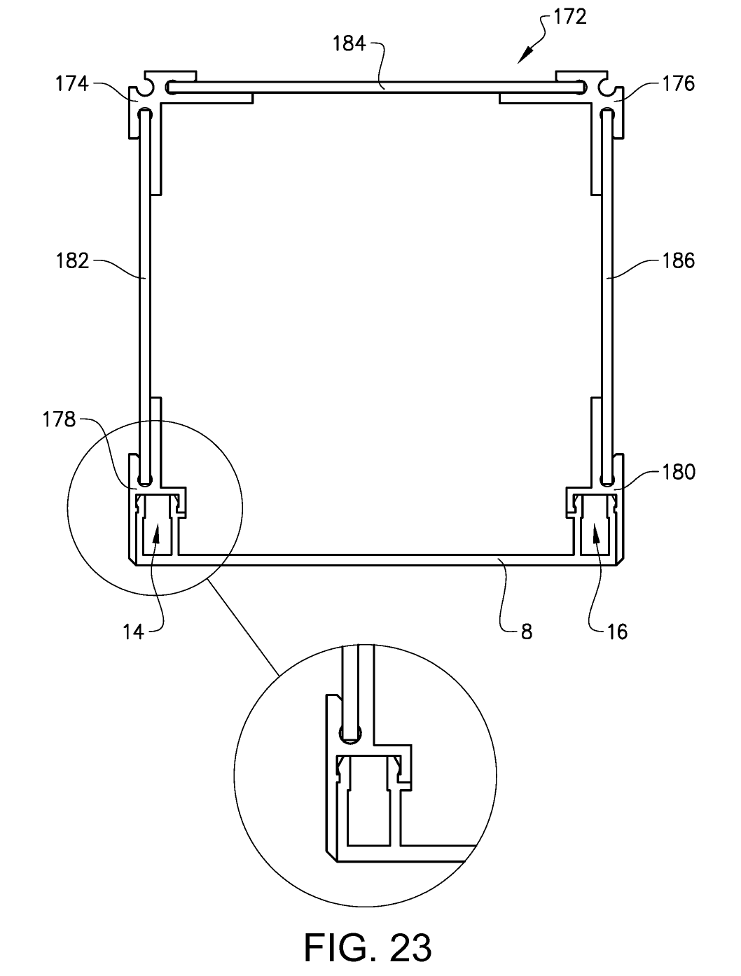

FIG. 23 discloses an alternative design of the elongated support member 172 in relation to the first embodiment in FIG. 2. The elongated support member 172 has a modular design, wherein four corners 174, 176, 178, 180 are adapted for engagement with edges of three intermediate side plates 182,184,186. The elongated support member 172 comprises the second engagement means 14,16 for engagement with the elongated cover 8. The extension of the side plates may be designed for different covering solutions and installation conditions.

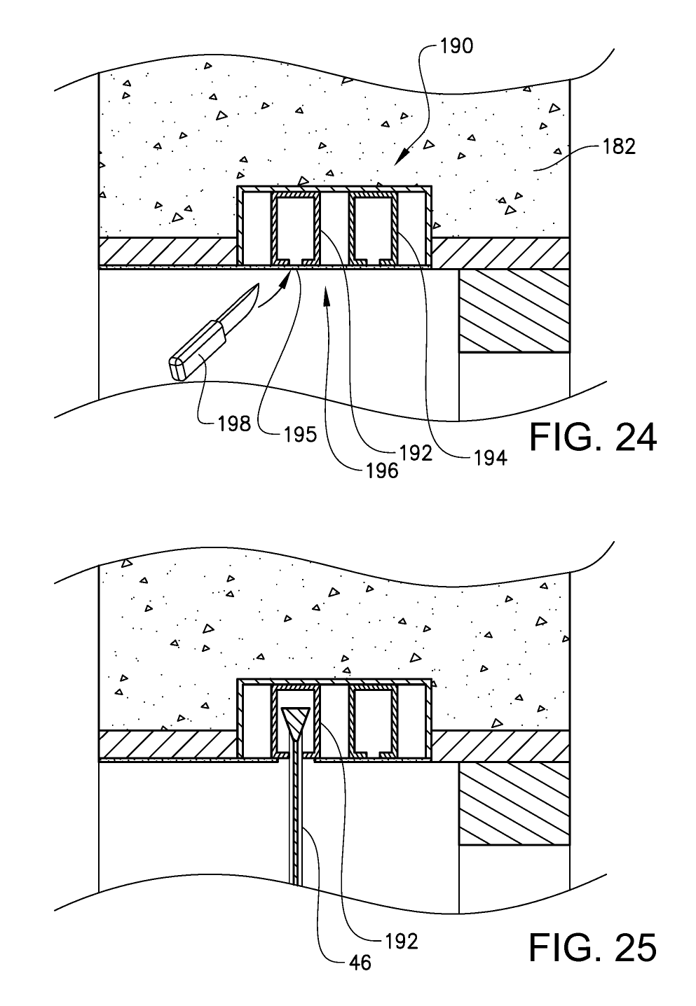

FIG. 24 shows a further embodiment of a support arrangement 190, which forms an alternative to the support arrangement shown in FIG. 8. The support arrangement 190 comprises two guides 192, 194, which are pre-installed. More specifically, the two guides may be attached to the elongated support member 56 before the support member 56 is installed into the wall or after installation of the support member 56 in the wall. Alternatively, the two guides may be formed in a one-piece unit with the elongated support member. The support arrangement 190 comprises a closing structure 196, which comprises material 195, which is removably connected to the wall portion 82 defining the opening. For example, the closing structure material 195 may be formed by a thin board, filler, carpet or any other type of building material for finishing a wall. Further, the closing structure material 195 is then applied flush with the adjacent surfaces of the wall portion so that the two guides 192, 194 are at least substantially completely concealed. Thus, the wall portion is thereby prepared for installation of a covering solution.

If it is later decided to install a covering in the opening, a portion of the closing structure material will be removed for accessing the guide(s). The removal of the closing structure material 195 may be accomplished via some kind of tool, like a cutting tool 198. The closing structure material may comprise an external indication indicative of the position of the guide(s). According to an alternative, the closing structure material is prepared for removal of said portion via a strip or similar arranged commensurate with the position of the guide(s).

FIG. 25 shows the support arrangement 190 according to FIG. 24 with a covering 46 installed in the guide 192 that has been made available via the removal of closing structure material.

From the above examples, it is clear that the support arrangement is adapted to be arranged in the wall portion defining the opening in a non-operative state, in which the closing structure at least substantially conceals the at least one elongated support member and arranged in such a way that it is accessible for activation to an operative state, when desired by removal of at least a part of the closing structure.

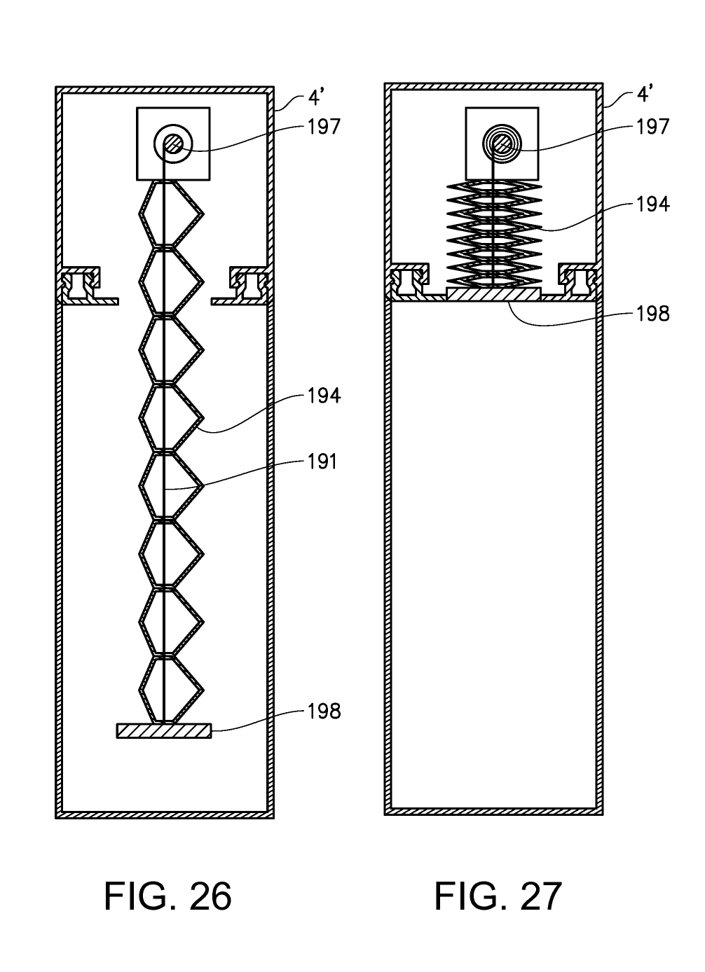

FIG. 26-27 show an alternative type of covering 194 for being used in association with the support arrangement. More specifically, the covering 194 is adapted to be arranged in a compressed state in the retracted state, see FIG. 27, and in an extended state, see FIG. 26. More specifically, the covering 194 is foldable and folded in the compressed state. The covering 194 may be formed by a fabric and may define a hollow structure. More specifically, covering 194 may be formed by a single wall structure or a double wall structure as seen in the figure. The fabric is held together by cords 191 that run through the material. Further, a roll 197 is arranged inside the elongated support member 4′, wherein the cords 191 are attached at one end to the roll and to a cross bar 198 at the other end, wherein the cross bar compresses the fabric when the roll is turned in a first direction and extends the fabric when the roll is turned in the other direction.

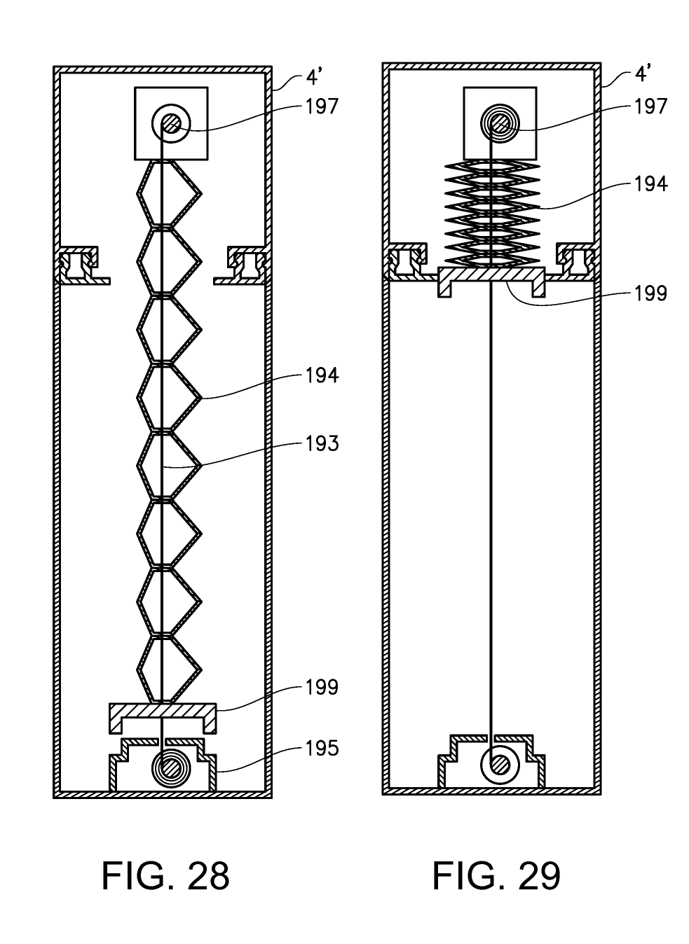

FIG. 28-29 show a further alternative type of covering 194 for being used in association with the support arrangement. This alternative differs from FIG. 26-27 in that there is a fixed bottom bar 195, wherein the cords 193 run between the roll and the fixed bottom bar 195.

Further, there is an intermediate cross bar 199 movably arranged along the cords 193 for compressing the fabric when the roll is turned in a first direction and extending the fabric when the roll is turned in the other direction.

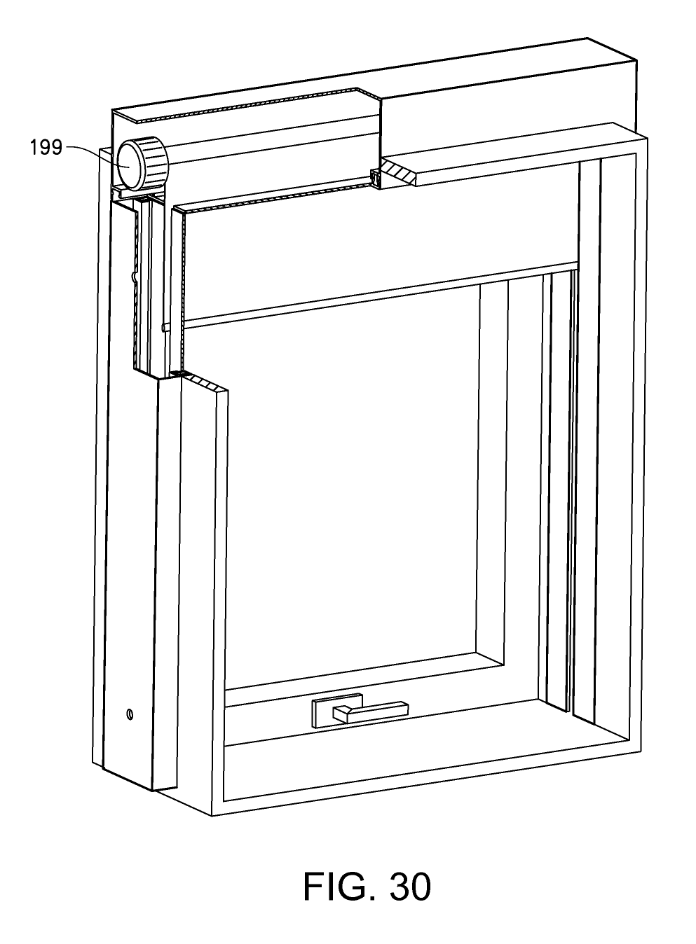

FIG. 30 discloses that the support arrangement may comprise a motor 199 for operating the covering(s) between the retracted state and the extended state.

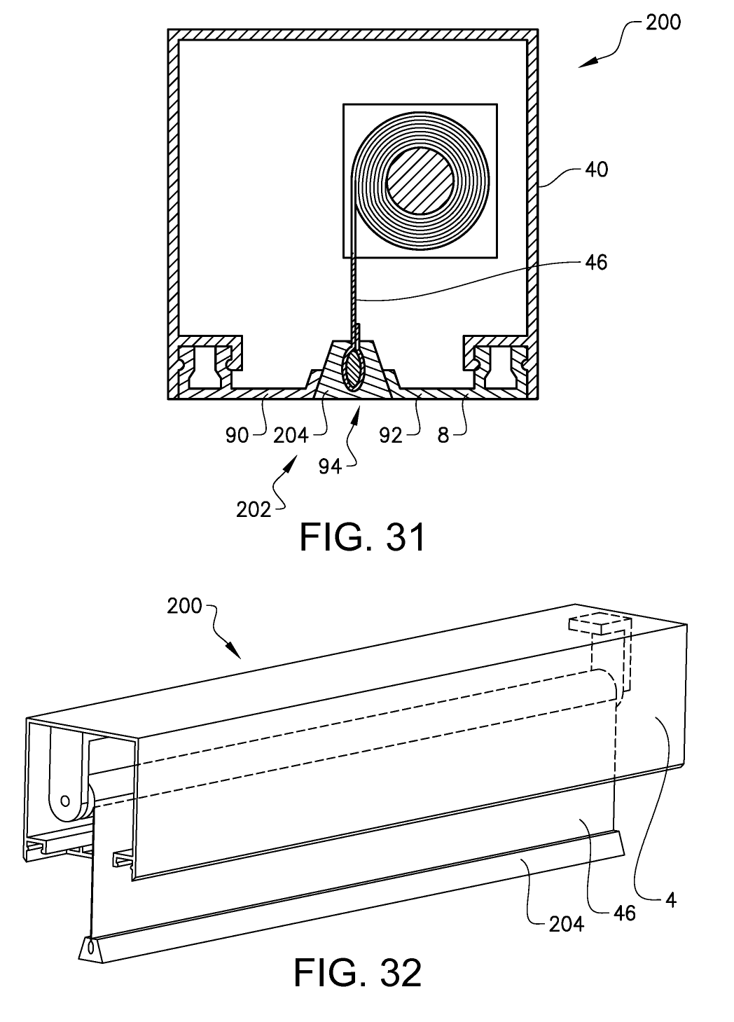

FIG. 31 shows a support arrangement 200 according to a further embodiment forming an alternative to the support arrangement 2 according to the first embodiment shown in FIG. 1-2. The support arrangement 200 is shown in cross section with a covering 46 applied. The support arrangement 200 comprises a closing structure 202, which in turn comprises an elongated cover member 204, which is attached to an edge of the covering 46. Further, the elongated cover member 204 and the at least one elongated cover 8 being designed so that the elongated cover member 204 at least substantially blocks a passage for the covering passed the at least one elongated cover when the covering is in the retracted state. More specifically, the elongated cover member 204 is adapted to block the slot 94 between the elongated covers 90, 92.

The elongated cover member 204 has an exterior shape and dimension matching the parts of the elongated covers 90, 92 defining the slot 94. More specifically, the parts of the elongated covers 90, 92 defining the slot 94 forms a narrowing passage for guiding the elongated cover member 204 to a seat. Further, the elongated cover member 204 has an exterior tapering shape for matching with the narrowing passage. More specifically, the elongated cover member 204 has the shape of a truncated cone.

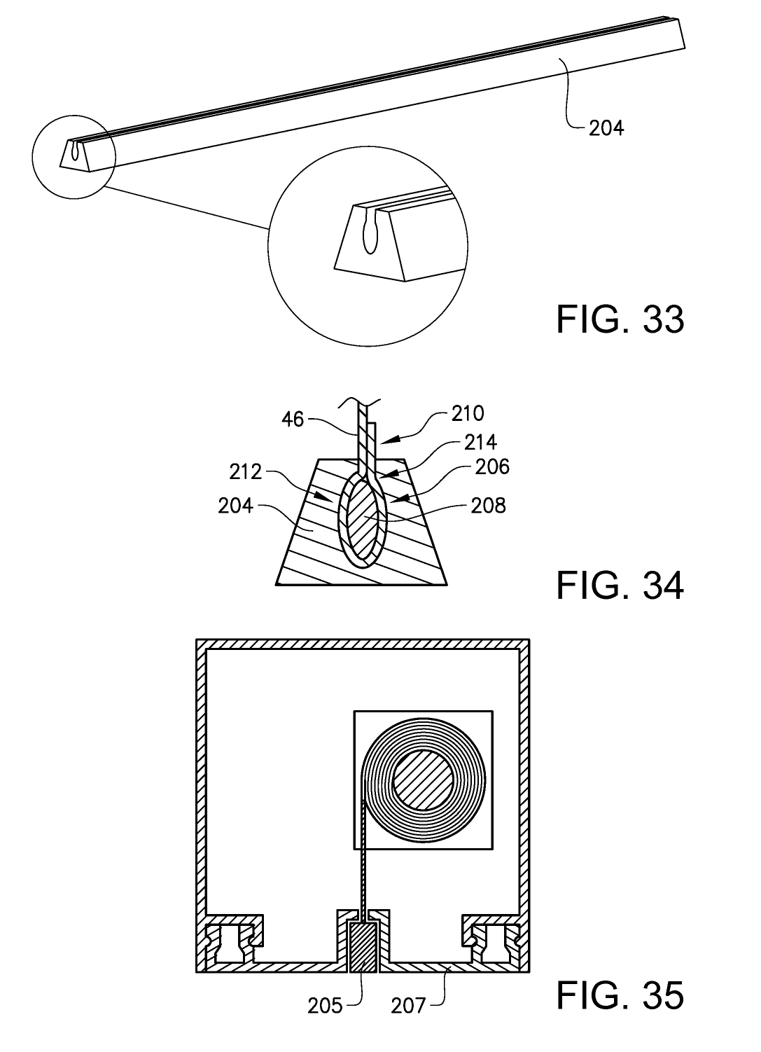

FIG. 32 shows the support arrangement 200 according to FIG. 31 in a perspective view, wherein the covering 46 is partly extended. FIG. 33 shows the elongated cover member 204 in a perspective view. FIG. 34 shows the edge 206 of the covering 46 extending perpendicular to an extension direction of the covering between the retracted state and the extended state. An end of the fabric of the covering forms a loop around a pin 208 and is fastened via stitches, glue or similar 210. The elongated cover member 204 comprises a channel 212 for receipt of the covering edge 206. The channel 212 has a narrow portion 214 for a firm attachment of the elongated cover member 204 to the covering 46.

FIG. 35 shows an alternative design of the elongated cover member 205 and the associated elongated cover 207. The exterior surface of the elongated cover member 205 and the interior surface of the associated elongated cover 207 are flat and in parallel with an extension direction of the covering 46.

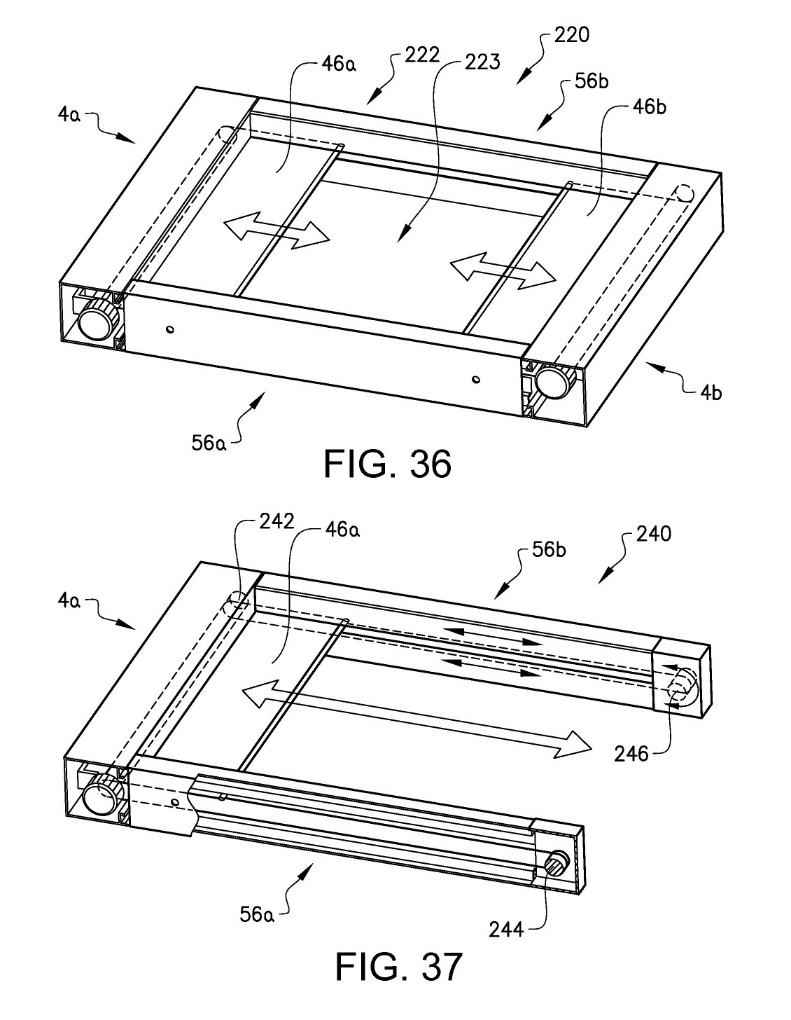

FIG. 36 shows a roof portion 220 comprising a support arrangement 222 according to a further embodiment. It is a so called skylight design. The support arrangement 222 is an alternative to the support arrangement according to FIG. 6. Only the main differences will be described below. The support arrangement 222 comprises a further elongated support member 4b accommodating a further covering 46b arranged opposite the elongated support member 4a accommodating the covering 46a in relation to a window opening 223 so that the apertures for the coverings 46a, 46b face each other. In other words, the support arrangement 222 forms a frame with a rectangular shape, wherein the support arrangement 222 extends along all four sides of the rectangle. According to the example in FIG. 34, the two coverings 46a, 46b extend along the same slot in the sideways support arrangements. Thus, the facing edges of the two coverings 46a, 46b may meet when the coverings jointly cover the window opening. According to an alternative, the sideways support arrangements are provided with two slots, one for each covering 46a, 46b, so that each covering may extend for completely covering the roof opening.

FIG. 37 shows an alternative support arrangement 240 similar to the one shown in FIG. 36, but without the further elongated support member 4b for accommodating a further covering 46b. More specifically, the covering 46a is rolled on a roll 242 rotatably arranged inside the associated elongated support member. A roll member 244, 246 is arranged at an opposite end of each one of the sideways elongated support members, wherein a cord from the roll forms a loop around its associated roll member 244,246. The covering 46a is to the cords for extension and retraction along the cord extension.

It is to be understood that the present invention is not limited to the embodiments described above and illustrated in the drawings; rather, the skilled person will recognize that many changes and modifications may be made within the scope of the appended claims.

Even though the support arrangements according to the first and second embodiments in FIGS. 1-2 and 3-4 have been described for a joint application in FIG. 5, it should not be regarded as limiting example. Instead, each one of the support arrangements according to the first and second embodiments may be used separately or in other combinations with each other.

Although the invention has been described above for a covering in the form of a sheet of fabric rolled on a roll and a honeycomb structure, other types include a covering made up of several long horizontal or vertical slats of various types of hard material, including wood, plastic or metal which are held together by cords that run through the blind slats are conceivable.

1. A wall or roof portion defining an opening, wherein the wall or roof portion is provided with a support arrangement for supporting at least one extendable covering, the covering being arranged for movement between a retracted state and an extended state for at least partly covering the opening, wherein the support arrangement comprises at least one elongated support member adapted to be attached to the wall portion or roof portion defining the opening, wherein the support arrangement comprises a closing structure for at least substantially concealing the elongated support member, wherein the closing structure comprises at least one elongated cover, which is adapted for connection to the at least one elongated support member in a way that a longitudinal direction of the at least one elongated cover is in parallel with a longitudinal direction of the at least one elongated support member in a connected state, wherein the at least one elongated cover comprises a first engagement means and the at least one elongated support member comprises a second engagement means, wherein the first and second engagement means are adapted for a detachable connection of the at least one elongated cover to the at least one elongated support member, wherein the at least one elongated support member and the at least one elongated cover are adapted to jointly define a substantially rectangular shape in a cross section perpendicular to the longitudinal direction when the at least one elongated cover and the at least one elongated support member are in a connected state, that the elongated support member comprises a back wall and two spaced side walls forming three sides of the rectangle and that the wall or roof portion has an elongated groove receiving of one of the at least one elongated support member in such a way that an exterior surface of the at least one elongated cover is at least substantially flush with the adjacent surface of the wall or roof portion.

2. A wall or roof portion according to claim 1, wherein the closing structure comprises a plurality of elongated covers, wherein at least one pair of the elongated covers is adapted to form a slot for the covering.

3. A wall or roof portion according to claim 1, wherein each one of the first and second engagement means defines an elongated shape in parallel with the longitudinal direction of the respective one of the at least one elongated support member and the at least one elongated cover.

4. A wall or roof portion according to claim 1, wherein the at least one elongated support member has a shape defining an elongated aperture extending in parallel with the longitudinal direction of the at least one elongated support member and the at least one elongated cover is adapted to at least substantially close the elongated aperture when the at least one elongated cover and the at least one elongated support member are in a connected state.

5. A wall or roof portion according to claim 1, wherein one of the at least one elongated support member and/or one of the associated at least one elongated cover is adapted for supporting an edge of the at least one extendable covering, which edge is in parallel with a movement direction between the retracted state and the extended state.

6. A wall or roof portion according to claim 1, wherein one of the at least one elongated support member is adapted for accommodating the at least one extendable covering in the retracted state.

7. A wall or roof portion according to claim 1, wherein one of the at least one elongated support member is adapted for accommodating at least two extendable coverings in the retracted state.

8. A wall or roof portion according to claim 6, wherein one of the at least one elongated cover is adapted for a connection to the associated at least one elongated support member allowing a portion of the at least one extendable covering to extend passed the at least one elongated cover when the at least one extendable covering is in the extended state.

9. A wall or roof portion according to claim 8, wherein the closing structure comprises an elongated cover member, which is adapted for being attached to an edge of the covering, and wherein the elongated cover member and the at least one elongated cover being designed so that the elongated cover member at least substantially blocks a passage for the covering passed the at least one elongated cover when the covering is in the retracted state.

10. A wall or roof portion according to claim 5, wherein one of the at least one elongated support member is adapted for accommodating the at least one extendable covering in the retracted state, and wherein the at least one elongated support member adapted for accommodating the covering in the retracted state and the elongated support member adapted for supporting an edge of the covering are arranged in relation to each other in such a way that the longitudinal directions of the two elongated support members are substantially perpendicular to each other.

11. A wall or roof portion according to claim 1, wherein the at least one elongated support member has a shape defining an elongated aperture extending in parallel with the longitudinal direction of the at least one elongated support member and the at least one elongated cover is adapted to at least substantially close the elongated aperture when the at least one elongated cover and the at least one elongated support member are in a connected state, wherein one of the at least one elongated support member and/or one of the associated at least one elongated cover is adapted for supporting an edge of the at least one extendable covering, which edge is in parallel with a movement direction between the retracted state and the extended state, wherein one of the at least one elongated support member is adapted for accommodating the at least one extendable covering in the retracted state, wherein the at least one elongated support member adapted for accommodating the covering in the retracted state and the elongated support member adapted for supporting an edge of the covering are arranged in relation to each other in such a way that the longitudinal directions of the two elongated support members are substantially perpendicular to each other, and wherein the at least one elongated support member adapted for supporting an edge of the extendable covering has a width of the aperture substantially commensurate with a width of a corresponding elongated aperture of the at least one elongated support member adapted for accommodating the extendable covering in the retracted state.

12. A wall or roof portion according to claim 1, wherein the closing structure comprises material, which is adapted for being removably connected to the wall portion or roof portion defining the opening.

13. A wall or roof portion according to claim 1, wherein the support arrangement is adapted to be arranged in the wall portion or roof portion defining the opening in a non-operative state, in which the closing structure at least substantially conceals the at least one elongated support member and arranged in such a way that it is accessible for activation to an operative state, when desired by removal of at least a part of the closing structure.

14. A wall or roof portion according to claim 13, wherein the closing structure comprises an elongated cover adapted for completely concealing the elongated support member in the non-operative state and wherein the elongated cover is detachably arranged for being exchanged to a plurality of elongated covers in the operative state.

15. A wall or roof portion according to claim 1, wherein the support arrangement comprises at least one means for holding the extendable covering.

16. A method for mounting a support arrangement in a wall or roof portion for supporting at least one extendable covering, the covering being arranged for movement between a retracted state and an extended state for at least partly covering an opening in the wall or roof portion, the method comprising
attaching at least one elongated support member of the support arrangement to the wall portion or roof portion defining the opening,
applying a closing structure for at least substantially concealing the at least one elongated support member,
connecting at least one elongated cover of the support arrangement to the elongated support member in a way that a longitudinal direction of the elongated cover is in parallel with a longitudinal direction of the elongated support member,
providing the wall or roof portion with an elongated groove adapted for receipt of one of the at least one elongated support member in such a way that an exterior surface of the at least one elongated cover is at least substantially flush with the adjacent surface of the wall or roof portion and the step of mounting the support arrangement in the groove, wherein the at least one elongated support member and the at least one elongated cover are adapted to jointly define a substantially rectangular shape in a cross section perpendicular to the longitudinal direction when the at least one elongated cover and the at least one elongated support member are in a connected state, that and the elongated support member comprises a back wall and two spaced side walls forming three sides of the rectangle.

17. A method according to claim 16, comprising building the support arrangement into the wall portion or roof portion in a non-operative state, in which the closing structure at least substantially conceals the elongated support member and arranged in such a way that it is accessible for activation to an operative state, when desired by removal of at least a part of the closing structure.

18. A support arrangement for mounting in a wall or roof for supporting at least one extendable covering, the covering being arranged for movement between a retracted state and an extended state for at least partly covering an opening in the wall or roof, wherein the support arrangement comprises at least one elongated support member adapted to be attached to a wall portion or roof portion defining the opening, wherein the support arrangement comprises a closing structure for at least substantially concealing the elongated support member, wherein the closing structure comprises at least one elongated cover, which is adapted for connection to the at least one elongated support member in a way that a longitudinal direction of the at least one elongated cover is in parallel with a longitudinal direction of the at least one elongated support member in a connected state, wherein the at least one elongated cover comprises a first engagement means and the at least one elongated support member comprises a second engagement means, wherein the first and second engagement means are adapted for a detachable connection of the at least one elongated cover to the at least one elongated support member, wherein the at least one elongated support member and the at least one elongated cover are adapted to jointly define a substantially rectangular shape in a cross section perpendicular to the longitudinal direction when the at least one elongated cover and the at least one elongated support member are in a connected state, wherein the elongated support member comprises a back wall and two spaced side walls forming three sides of the rectangle, wherein one of the at least one elongated support member and one of the associated at least one elongated cover form a sideways support structure and is adapted for supporting an edge of the at least one extendable covering, which edge is in parallel with a movement direction between the retracted state and the extended state.

19. A support arrangement according to claim 18, wherein one of the at least one elongated support member is adapted for accommodating the at least one extendable covering in the retracted state.

20. A support arrangement according to claim 18, wherein the at least one elongated support member adapted for accommodating the covering in the retracted state and the elongated support member adapted for supporting an edge of the covering are arranged in relation to each other in such a way that the longitudinal directions of the two elongated support members are substantially perpendicular to each other.

21-29. (canceled)
